(19) United States
(12) Patent Application Publication
(10) Pub. No.: US 2014/0165761 A1
(43) Pub. Date: Jun. 19, 2014

(54) Drive transmission part for image forming apparatus

(71) Applicant: Mitsubishi Kagaku Imaging Corporation, Glendale, CA (US)

(72) Inventors: Kozo Ishio, Virginia Beach, VA (US); William F. Niederstadt, Chesapeake, VA (US); Mark J. Winfield, Chesapeake, VA (US); James H. Rivoir, Suffolk, VA (US); Jason V. Roberts, Chesapeake, VA (US); Seth R. Brunner, Virginia Beach, VA (US); Denny Holmes, Los Angeles, CA (US); Tigran Ohanyan, Van Nuys, CA (US)

(73) Assignee: MITSUBISHI KAGAKU IMAGING CORPORATION, GLENDALE, CA (US)

(21) Appl. No.: 13/998,878

(22) Filed: Dec. 16, 2013

Related U.S. Application Data
(60) Provisional application No. 61/738,245, filed on Dec. 17, 2012.

(51) Int. Cl. F16H 55/02

(52) U.S. Cl. CPC F16H 55/02
USPC 74/431

(57) ABSTRACT

Drive transmission part and system including a coupling member configured to have one or more restricted degrees of freedom, and a gear hub to rotationally engage the coupling member. The drive transmission part can be included in a rotating part of an apparatus, such as an image forming apparatus

### CROSS REFERENCE TO RELATED APPLICATIONS

This application claims the benefit of U.S. Provisional Patent Application Ser. No. 61/738,245, filed Dec. 17, 2012, which is incorporated herein by reference in its entirety.

This disclosure relates to and incorporates by reference the entire content of U.S. 61/614,346, filed Mar. 22, 2012; U.S. 61/615,012, filed Mar. 23, 2012; U.S. 61/637,078, filed Apr. 23, 2012; U.S. 61/640,635, filed Apr. 30, 2012; U.S. 61/645,393, filed May 10, 2012; U.S. 61/648,488, filed May 17, 2012; U.S. 61/652,737, filed May 29, 2012; U.S. 61/673,056, filed Jul. 18, 2012; U.S. 61/682,593, filed Aug. 13, 2012; and, U.S. 61/698,168, filed Sep. 7, 2012.

### BACKGROUND

1. Field of the Disclosure

This disclosure is drawn to a drive transmission part for an electro-mechanical device, such as an image forming apparatus, which can be used with an organic photo conductor (OPC) drum or other rotating cylindrical part installed or to be installed in an image forming apparatus and/or a toner cartridge. Such an image forming apparatus can be an electrophotographic image forming apparatus, such as a laser, LED or similar type of printer, a facsimile device, or a multi-function document processing device including a printer.

2. Description of Related Art

U.S. Pat. No. 5,903,803 to Kawai et al. describes a transmission mechanism between a drive member and a driven member, specifically in the context of an OPC-type drum of an imaging cartridge. The drive member and the driven member can be described as male and female shafts or parts. The male part has an equilateral triangular cross-section, which twists, and the female part has a corresponding equilateral triangular cross-sectional shape to accept the male part having the twisting equilateral triangular cross-section. U.S. Pat. No. 5,903,803 to Kawai et al. is incorporated herein in its entirety by reference.

U.S. Pat. No. 7,885,575 to Batori et al. describes a coupler for an electrophotographic photosensitive drum flange, the drum is usable with a cartridge detachably mountable to a main assembly of an image forming apparatus. The coupler includes a receiving member to receive a drive shaft of the main assembly. The drive shaft has a semispherical shape and includes rotational force transmitting pins that engage the receiving member. A spherical portion is connected to the coupler via a pin that is inserted into a shaft of the coupler.

### SUMMARY

According to aspects of this disclosure, a directly corresponding male/female shape is not necessary. Similar and related aspects were discussed in related application U.S. 61/614,346, filed Mar. 22, 2012; related application U.S. 61/615,012, filed Mar. 23, 2012; related application U.S. 61/637,078, filed Apr. 23, 2012; related application U.S. 61/640,635, filed Apr. 30, 2012; related application U.S. 61/645,393, filed May 10, 2012; related application U.S. 61/648,488, filed May 17, 2012; related application U.S. 61/652,737, filed May 29, 2012; related application U.S. 61/673,056, filed Jul. 18, 2012; related application U.S. 61/682,593, filed Aug. 13, 2012; and related application U.S. 61/698,168, filed Sep. 7, 2012.

A rotating part can be installable in an image forming apparatus, and can include a coupling member configured to have one or more restricted degrees of freedom; and a gear hub to rotationally engage the coupling member.

A cover can be provided to at least partially control an alignment of a shaft the coupling member with respect to the gear hub. The cover can include a square slot, a rectangular slot, or a rectangular slot including one or more beveled edges to allow the shaft of the coupling member an angular degree of freedom. The cover can also have a circular or oval shaped slot that includes one or more beveled edges.

The coupling member can include a U-shaped base. The U-shaped base can include snap fittings to engage a pin that couples to the gear hub. The U-shaped base can be cylindrical or spherical. The pin can be inserted through an elongated slot of a snap-fit portion that is snap-fitted to the gear hub.

The coupling member and the gear hub can be coupled to each other by tabbed projections (projections that include tabs formed at ends of stems that extend through slots in a cover) that allow for a restricted rotational degree of freedom therebetween. The coupling member and the gear hub can be coupled to each other by projections that allow for a restricted rotational degree of freedom therebetween, where the projections include base stems and tabs provided at ends of the base stems. The stems can pass though a cover that is secured to the coupling member or the gear hub, where the tabs restrict a complete separation of the coupling member from the gear hub by engaging a surface of the cover.

The coupling member and the gear hub can be coupled to each other by a spring. The spring can be fitted to the gear hub such that is has a angular degree of rotational freedom at a fitting pivot point therewith.

The coupling member can have a T-bar, where the T-bar engages with a base surface of the gear hub with a rotational degree of freedom with respect to a rotational axis of the rotating part. The coupling member and the gear hub can be coupled to each other by a sleeved wire.

The coupling member and the gear hub can be coupled to each other by an x-shaped pin structure that provides at least two rotational degrees of freedom with respect to a longitudinal direction. The x-shaped pin structure can include two pins that are fixed to each at, e.g., respective middle portions thereof. One of the two pins can be snap-fit to respective snap-fit receiving parts of the gear hub.

The coupling member can have a T-bar and the gear hub can include a contoured base surface to receive the T-bar, where the contoured base surface has a slot with rounded entry surfaces.

The coupling member can have a T-bar, including a shaft and one or more bars extending laterally from an end of the shaft. The shaft can extends through a cover that includes a slot, where the cover is connected to the gear hub and the shaft extends through the slot. A diameter or dimension of the slot can be less than a length or corresponding dimension of the one or more bars, such that the cover restricts the coupling member from being completely disconnected from the gear hub.

A rotating part can include a cylindrical body including a photoconductor. An imaging cartridge for an image forming apparatus can include the rotating part, and an image forming apparatus can include the imaging cartridge.

The above description sets forth, rather broadly, a summary of the disclosed embodiments so that the detailed description that follows may be better understood and contributions of the invention to the art may be better appreciated. Some of the disclosed embodiments may not include all of the features or characteristics listed in the above summary. There may be, of course, other features of the disclosed embodiments that will be described below and may form the subject matter of claims.

The foregoing paragraphs have been provided by way of general introduction. The described embodiments, together with the attendant advantages thereof, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A-1D illustrate examples of a Concept A for coupling a coupling member to a gear hub;

FIGS. 2A-2B illustrate examples of a Concept B for coupling a coupling member to a gear hub;

FIGS. 3A-3G illustrate examples of a Concept C for coupling a coupling member to a gear hub;

FIGS. 4A-4M illustrate examples of a Concept D for coupling a coupling member to a gear hub;

FIGS. 5A-5D illustrate examples of a Concept E for coupling a coupling member to a gear hub;

FIGS. 6A-6E illustrate examples of a Concept F for coupling a coupling member to a gear hub;

FIGS. 7A-7E illustrate examples of a Concept G for coupling a coupling member to a gear hub; and

FIGS. 8A-8G illustrate examples of a Concept H for coupling a coupling member to a gear hub.

### DETAILED DESCRIPTION OF THE EMBODIMENTS

In the drawings, like reference numerals or characters, if applicable, designate identical or corresponding parts throughout the several views. Moreover, in certain embodiments, the parts shown in the Figures are to scale, such that optimal ratios and measurements for the parts can be derived directly from the Figures. Other aspects of this disclosure do not require the parts shown in Figures to be drawn to scale. Also, unless otherwise indicated, measurements indicated in the drawings are in units of millimeter or degrees with respect to a 360° coordinate system. Tolerances of these radial and angular dimensions can be within ±4-6° (degrees) while still remaining within the preferred shape and positioning of the features shown in the drawings. However, larger tolerances can be implemented without detracting from the scope of this disclosure. Similarly, tolerances of one millimeter are optimal, but can vary. Further, references to a longitudinal direction herein generally refer to a rotational axis of a rotating part, such as a drum or an OPC drum.

In U.S. Pat. No. 7,885,575 to Batori et al., a drive shaft can be coupled to drive transmitting means, such as a gear train and a motor provided in a main assembly. A free end portion of the drive shaft can have a substantially semispherical shape, and can be provided with rotational force transmitting pins. These pins can extend perpendicular (lateral) to a rotation axis of the drive shaft. A coupling member can include a receiving member that is configured to receive the drive shaft and be rotated by the pins.

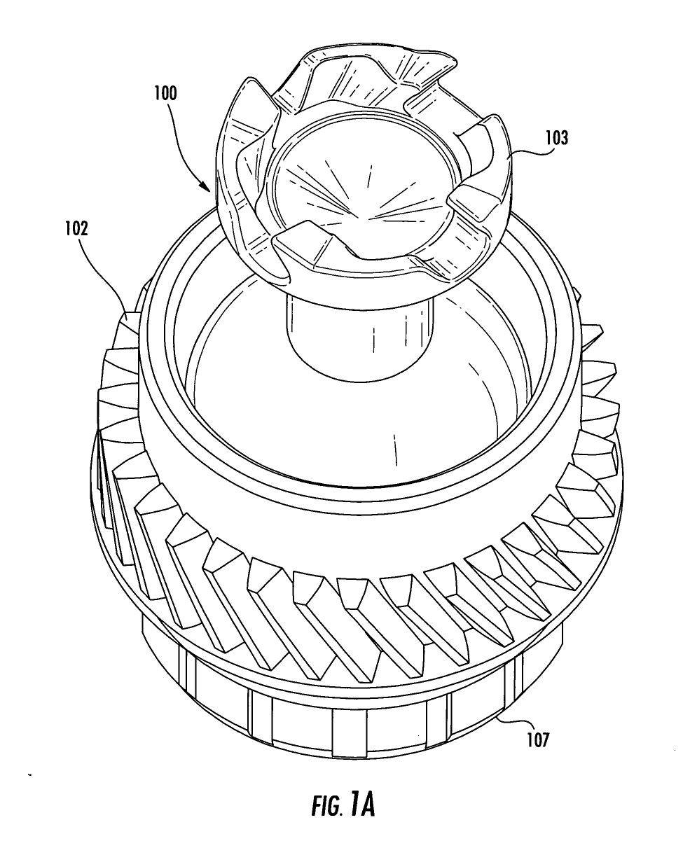

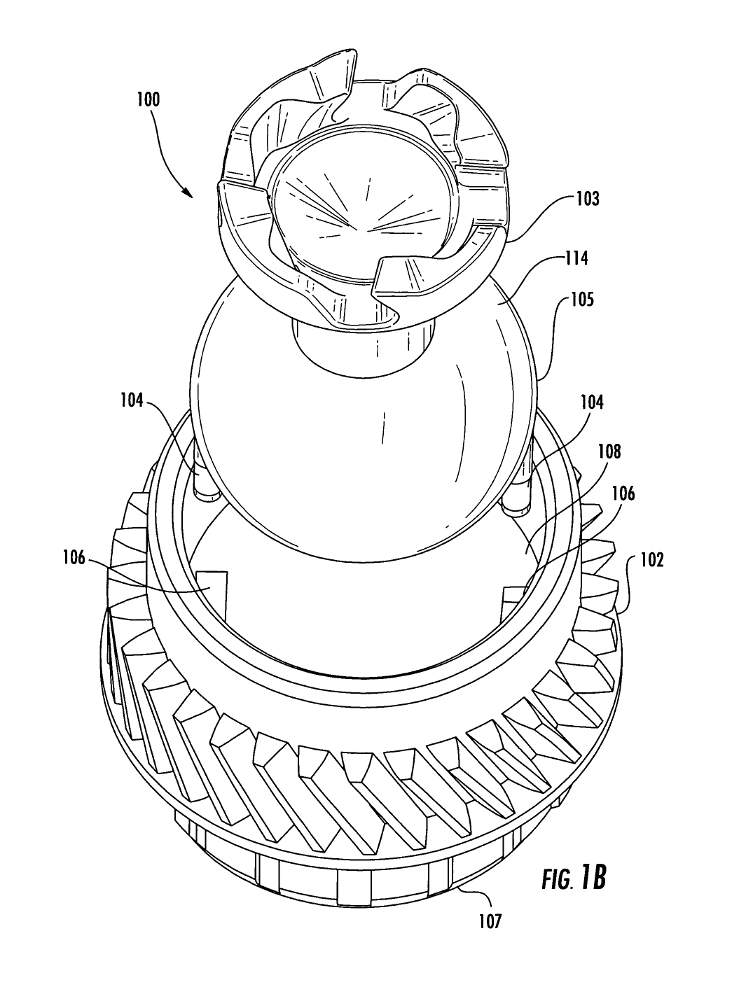

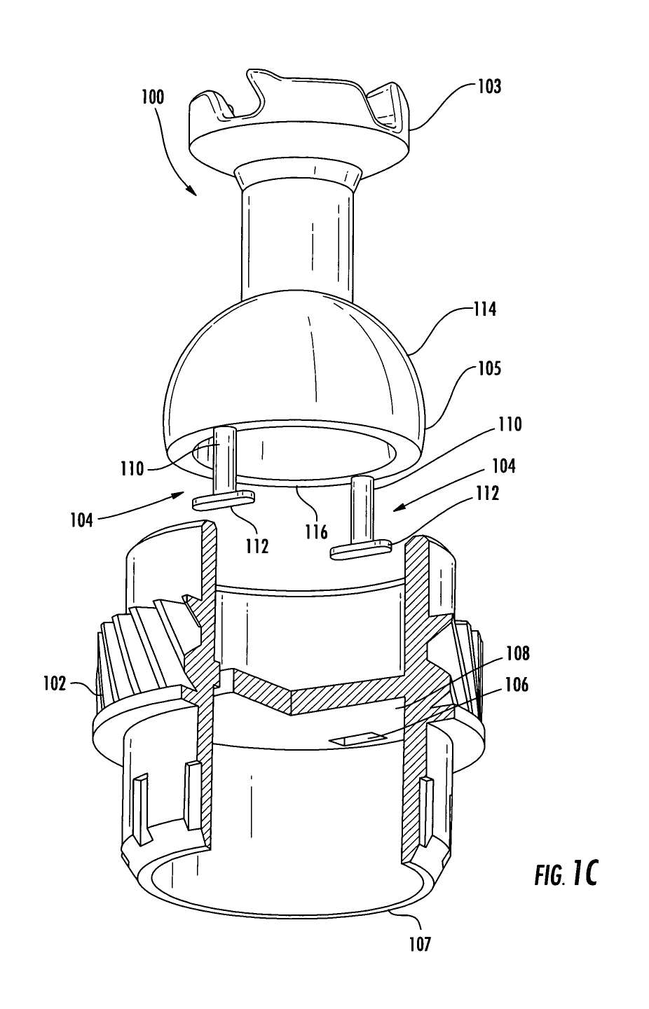

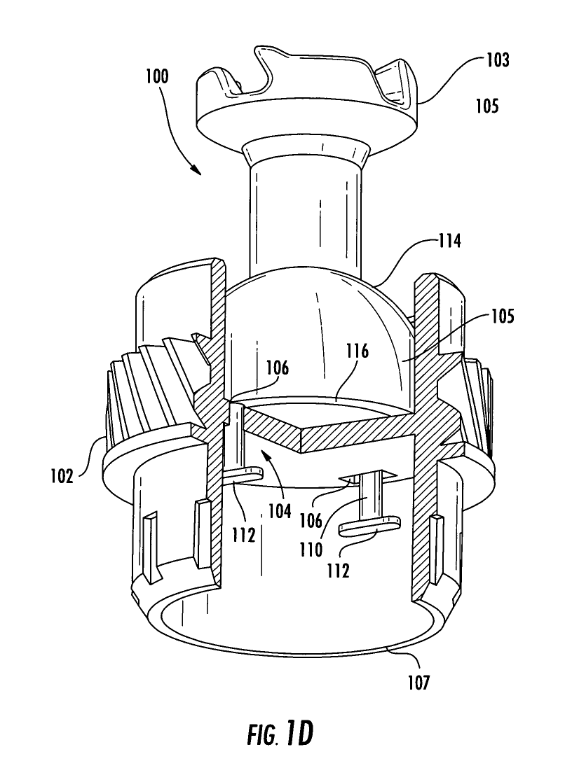

FIGS. 1A-8G show various embodiments of a rotating part installable in an image forming apparatus (not shown) comprising a coupling member 100, 200, 300, 400, 500, 600, 700, 800, configured to have one or more restricted degrees of freedom, and a gear hub 102, 202, 302, 402, 502, 602, 702, 802, to rotationally engage the coupling member 100, 200, 300, 400, 500, 600, 700, 800.

FIG. 1A illustrates a coupling member 100 according to a Concept A. In FIG. 1A, a receiving member portion 103 of the coupling member 100 is shown. The coupling member 100 is shown as being connected/coupled to a gear hub 102, which can be connected to a rotating part, not shown, such as a drum or an OPC drum, at a bottom portion 107 of the gear hub 102.

FIG. 1B illustrates the coupling member 100 and the gear hub 102 in a disconnected/decoupled, exploded view state. Here, it is shown that the coupling member 100 includes one or more (such as two) projections 104, which create a rotational engagement between the coupling member 100 and the gear hub 102. The projections 104 are configured to project from a base portion 105 of the coupling member 100 through slots 106 of a surface of a cover or plate 108 of the gear hub 102. In the example shown in FIG. 1B, two projections 104 are shown which are arranged to project from the coupling member 100 through the cover or plate 108 of the gear hub 102. The cover or plate 108 can alternatively be secured to the coupling member 100, where the projections 104 would then project from the gear hub 102.

FIG. 1C illustrates an alternative partial cut away view of the arrangement shown in FIG. 1B. Here, the structure of the projections 104 is shown as including a base stem 110 and a tab 112. The base stem 110 is arranged to slide in the slot 106 through the cover or plate 108, and the tab 112 is arranged to inhibit the coupling member 100 from being removed (or vise versa) from the gear hub 102 with respect to a longitudinal direction. With these structures, the coupling member 100 and the gear hub 102 have a relative restricted rotational degree of freedom, with respect to a rotational axis (longitudinal axis) of a rotating part, as well as a restricted longitudinal degree of freedom with respect to the longitudinal axis. FIG. 1D illustrates the coupling member 100 being connected to the gear hub 102 via the projections 104, and shows the tabs 112 and part of the base stems 110 inserted through the slots 106. Thus, as shown in FIG. 1D, the coupling member 100 and the gear hub 102 are coupled to each other by projections 104 that allow for a restricted rotational degree of freedom therebetween, the projections 104 including the base stems 110 and the tabs 112 provided at ends of the base stems 110. As further shown in FIG. 1D, the base stems 110 pass through slots 106 in the cover 108 that are spaced to correspond to the spacing between the tabs 112. The cover 108 is secured to the coupling member 100 or the gear hub 102, and the tabs 112 restrict a complete separation of the coupling member 100 from the gear hub 102 by engaging a surface of the cover 108.

In the above concept, the coupling member 100 has a generally spherical shape 114 (see FIG. 1B). However, the coupling member 100 may also have a generally U-shaped base and/or a generally cylindrically shaped base. The spherical shape 114 may allow for a degree of restricted freedom so as to allow an end portion 116 (see FIGS. 1C-1D) of the coupling member 100 to be angularly offset from the longitudinal axis. On the other hand, a U-shaped or a cylindrically shaped base may restrict or eliminate this particular degree of freedom.

As to a relative rotation between the coupling member 100 and the gear hub 102 (which itself can be fixedly secured to a rotating part), the relative restricted degree of freedom may be limited to a particular angular range. For example, a relative rotation of the coupling member 100 does not cause rotation of the rotating part or the gear hub 102 (or vice versa) for at least a portion of a full rotation. In the example shown, a rotational range for this portion of a full rotation may be between approximately 15°-45° (fifteen to forty-five degrees), such as about 30° (thirty degrees). This rotational range may also be referred to as a rotational degree of freedom, where the range of the rotational degree of freed is between approximately 15°-45° (fifteen to forty-five degrees), such as about 30° (thirty degrees).

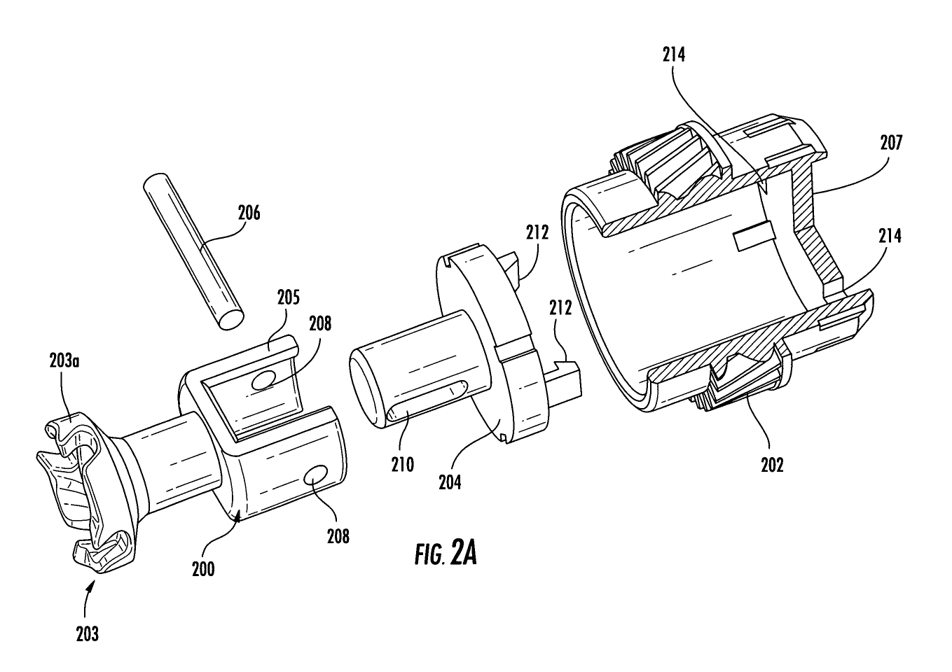

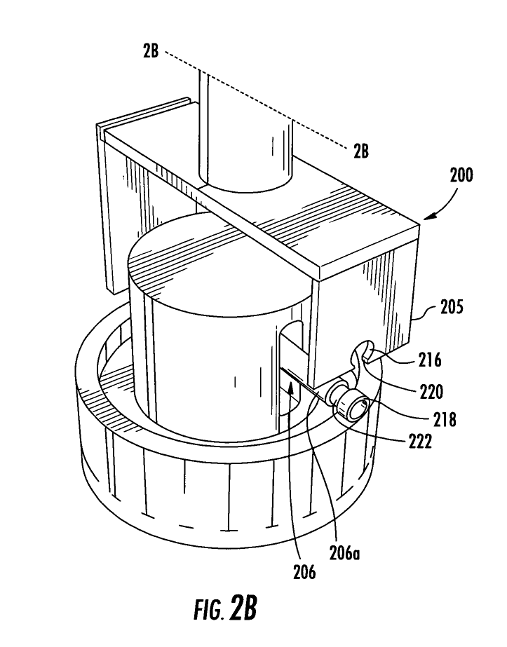

FIGS. 2A-2B illustrate aspects of a Concept B. In FIG. 2A, an exploded view is shown of a coupling member 200, a gear hub 202, and a snap-fit portion 204 disposed between the coupling member 200 and the gear hub 202. As shown in FIG. 2A, the coupling member 200 includes a receiving member portion 203. The receiving member portion 203 of the coupling member 200 is preferably in the form of a gear tooth receiving portion 203a and can be the same or different as the receiving member portion 103 shown in FIG. 1A. This same relationship can apply to the other concepts discussed herein. The coupling member 200 is preferably connected/coupled to the gear hub 202, which can be connected to a rotating part, not shown, such as a drum or an OPC drum, at a bottom portion 207 (see FIG. 2A) of the gear hub 202.

As shown in FIG. 2A, the coupling member 200 further comprises a U-shaped base portion 205. The U-shaped base is preferably a cylindrical shape. The U-shaped base portion 205 includes two holes 208 that coincide with elongated slots 210 (see FIG. 2A) of the snap-fit portion 204. A pin 206 slides through the two holes 208 of the U-shaped base portion 205 and the elongated slots 210 to engage the coupling member 200 to the snap-fit portion 204. The pin 206 may be inserted through elongated slots 210 formed in the snap-fit portion 204 that is snap-fitted to the gear hub 202. This engagement allows for a relative longitudinal movement and may also allow for relative angular movement (at an angle with respect to the longitudinal movement) with the pin 206 as an axis of rotation. The snap-fit portion 204 includes one or more (such as two) snap hooks 212 that are configured to snap-fit into corresponding slots 214 of the gear hub 202.

FIG. 2B illustrates a simplified schematic of a modification to Concept B (Concept B mod). That is, in FIG. 2B, some features are illustrated as simplified or exaggerated to emphasize distinctions. In FIG. 2B, the components shown are generally the same as those shown in FIG. 2A. However, the coupling member 200, and specifically the U-shaped base portion 205 thereof, is modified such that the pin 206, such as in the form of grooved pin 206a, does not pass through holes 208 (see FIG. 2A) of the U-shaped base portion 205. Rather, as shown in FIG. 2B, the holes 208 of FIG. 2A, are replaced with snap-fit portions 216 that engage respective ends 218 of the grooved pin 206a that extends through the slot 220 of the snap-fit portion 216. The grooved pin 206a shown in FIG. 2B is merely exemplary. The grooved pin 206a may have a recessed groove 222 at each end 218 of the grooved pin 206a, as shown in FIG. 2B, to inhibit movement of the grooved pin 206a relative to the U-shaped base portion 205 and/or the snap-fit portion 216. A receiving member portion 203 (see FIG. 2A) that is similar to or the same as the receiving member portion 203 of the coupling member 200 shown in FIG. 2A may be attached to the coupling member 200 shown in FIG. 2B along, e.g., line 2B-2B.

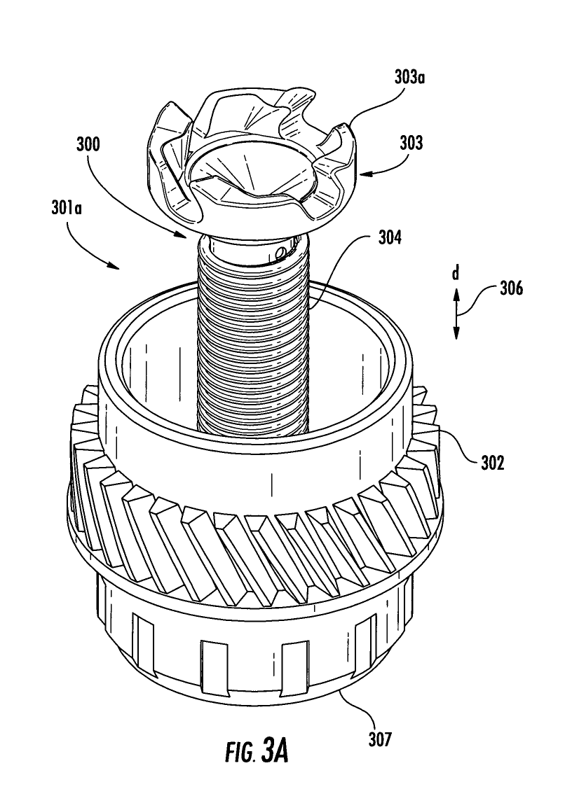

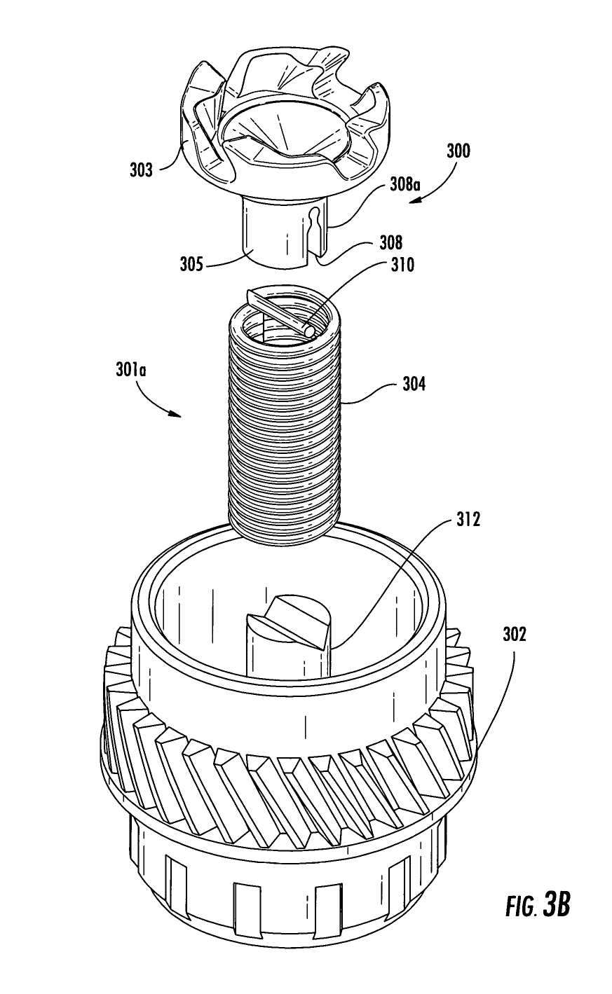

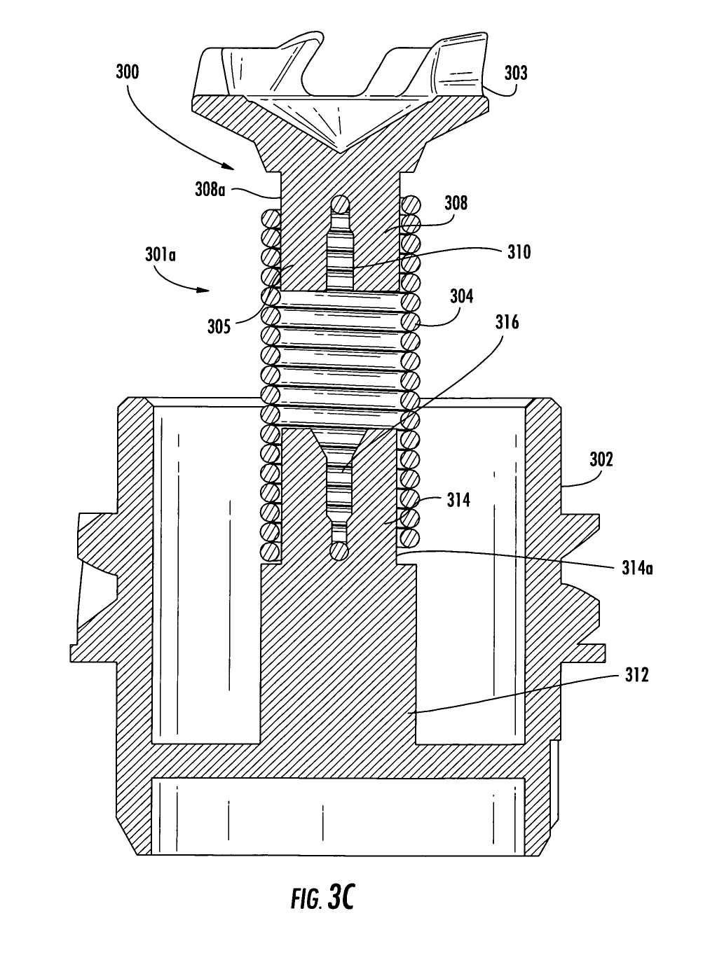

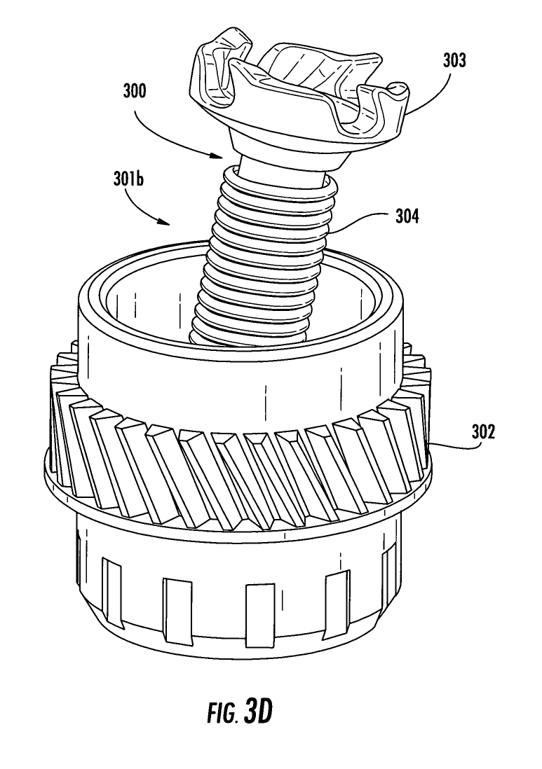

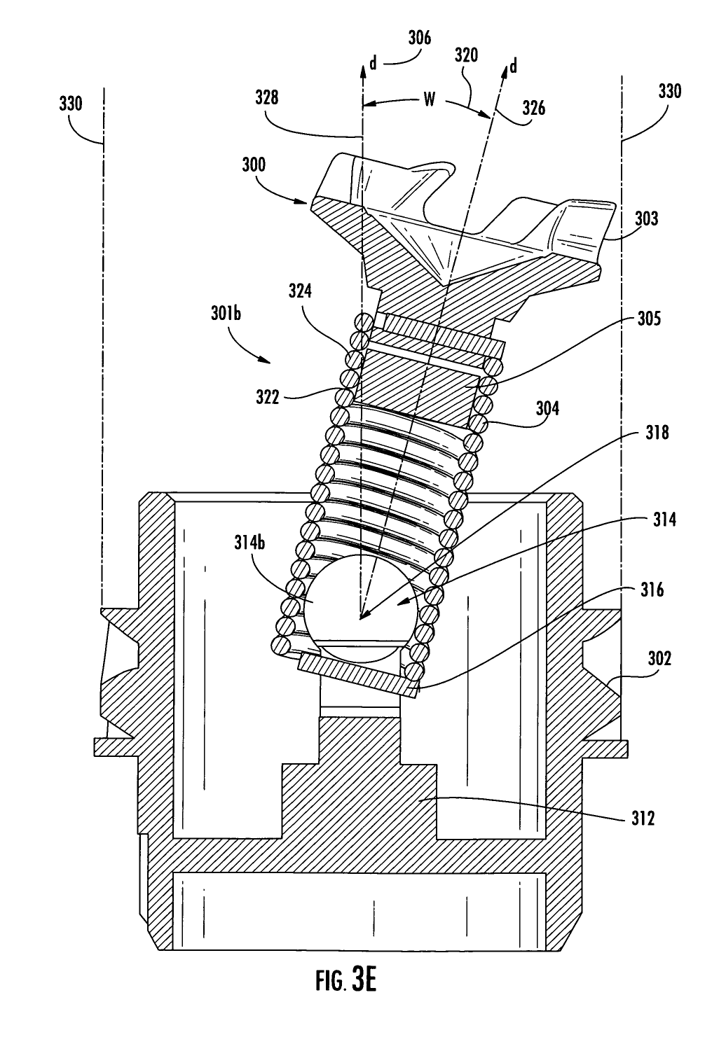

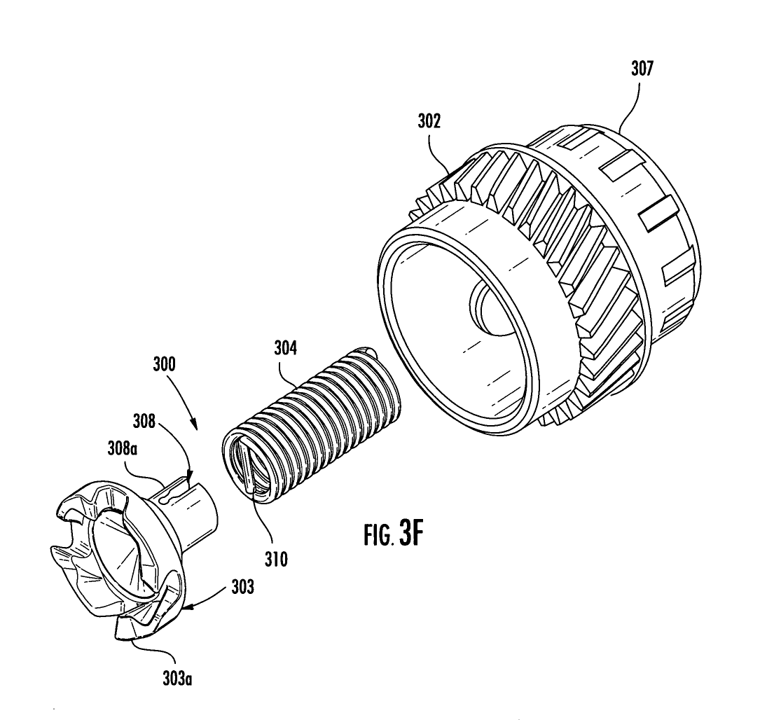

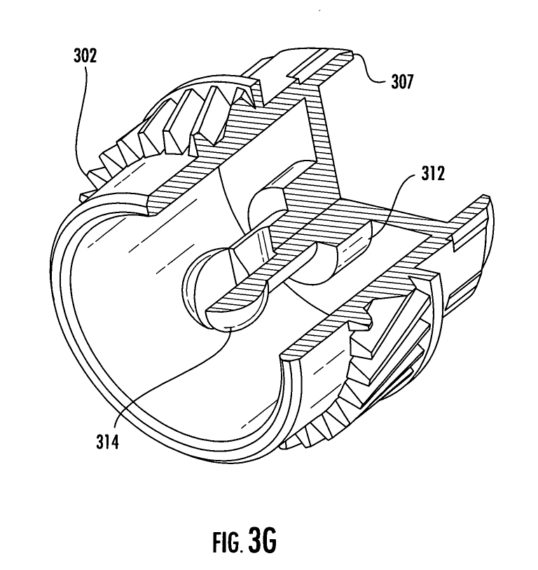

FIGS. 3A-3G illustrate various views of two aspects of a Concept C. FIGS. 3A-3C illustrate the first aspect of Concept C, whereas FIGS. 3D-3G illustrate the second aspect of Concept C.

FIGS. 3A-3F show a coupling member 300, a gear hub 302, and a spring member 304 disposed between the coupling member 300 and the gear hub 302. As shown in FIGS. 3A-3F, the coupling member 300 includes a receiving member portion 303. The receiving member portion 303 of the coupling member 300 is preferably in the form of a gear tooth receiving portion 303a and can be the same as or different from the receiving member portion 103 shown in FIG. 1A. The coupling member 300 is preferably connected/coupled to the gear hub 302, which can be connected to a rotating part, not shown, such as a drum or an OPC drum, at a bottom portion 307 (see FIGS. 3A, 3F) of the gear hub 302.

As shown in FIGS. 3A-3C, the first aspect of Concept C will be referred to as a “straight spring” aspect 301a, in which the spring member 304 is secured to the gear hub 302 so as to be coaxial with a longitudinal direction (d) 306 (see FIG. 3A). The second aspect will be referred to as an “angled spring” aspect 301b, in which the spring member 304 is secured to the gear hub 302, so as to be able to be coaxial with the longitudinal direction (d) 306 (see FIG. 3E), and also so that the spring member 304 an has angular degree of freedom that allows the spring portion 304 to be able to rotate (relative to the gear hub 302) to angularly displace the spring member 304 relative to the longitudinal direction (d) 306 (see FIG. 3E).

In both of these aspects 301a, 301b, the coupling member 300 has a base portion 305 (see FIGS. 3B, 3F) that includes a snap fitting 308 (see FIGS. 3B, 3C, 3F) in the form of a dual arm snap fitting 308a (see FIGS. 3B, 3F) to receive a first portion 310 (see FIGS. 3B, 3F) of the spring member 304, which is preferably made of a metal or metal alloy. In both of these aspects 301a, 301b, the gear hub 302 has a central portion 312 (see FIGS. 3B, 3C, 3E) that includes one or more snap fittings 314 (see FIGS. 3C, 3E) to receive a second portion 316 (see FIGS. 3C, 3E) of the spring member 304, which is preferably made of a metal or metal alloy. As shown in FIG. 3C, the snap fitting 314 is in the form of a dual arm snap fitting 314a. As shown in FIG. 3E, the snap fitting 314 is in the form of a ball snap fitting 314b. The spring member 304 allows for flexibility in alignment of the coupling member 300 with respect to a position/orientation of the gear hub 302, but allows for a relatively rigid transmission of rotational movement (torque) and little to no relative longitudinal extension.

In the straight spring aspect 301a, as shown in FIGS. 3C-3D, the snap fitting 314 (see FIG. 3C) on the gear hub 202 is a relatively rigid fitting which holds the spring member 304 in the longitudinal direction (d) 306 (see FIG. 3A). On the other hand, as shown in FIG. 3E, in the angled spring aspect 301b, the snap fitting 314 on the gear hub 302 holds the spring member 304 at a fitting pivot point 318, which allows the spring member 304 to rotate (angularly displace) with respect to at least one dimension. The spring member 304 is preferably fitted to the gear hub 302, such that the spring member 304 has an angular degree of rotational freedom at the fitting pivot point 318 therewith.

As shown in FIG. 3E, the snap fitting 314, such as in the form of ball snap fitting 314b, is designed so as to restrict the angular movement of the spring member 304 to range of W degrees 320, where W can be between about 15° (fifteen degrees) and 45° (forty-five degrees), such as approximately 30° (thirty degrees). As shown in FIG. 3E, this degree of freedom can be controlled by the shape of the snap fitting 314 such that an end 322 of the coupling member 300 maintains a position 324 that does not extend, in a direction (d) 326 lateral to a longitudinal axis 328, past a furthest lateral position 330 of the gear hub 302. This furthest lateral position 330 is shown by the dotted lines in FIG. 3E. The spring member 304 shown in FIGS. 3A-3F are exemplary components which may be generic to both the straight spring aspect 301a and the angled spring aspect 301b. FIG. 3G shows the gear hub 302 with cut away portions of the central portion 312 and the snap fitting 314.

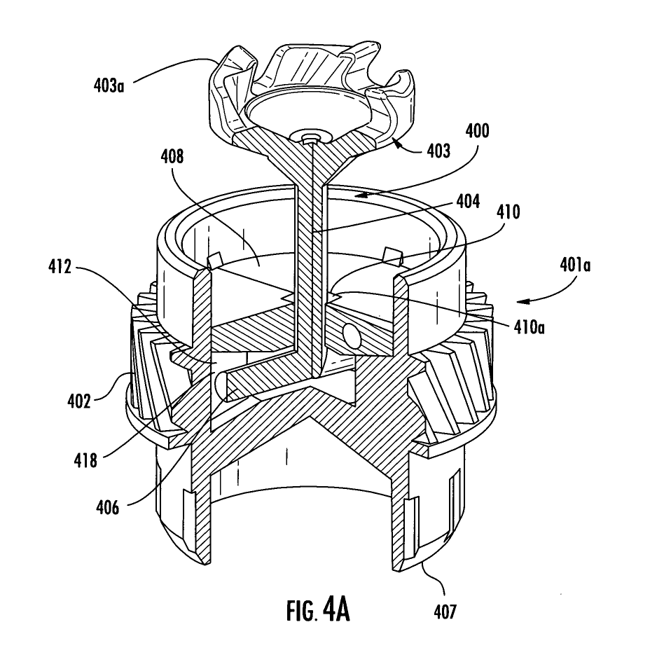

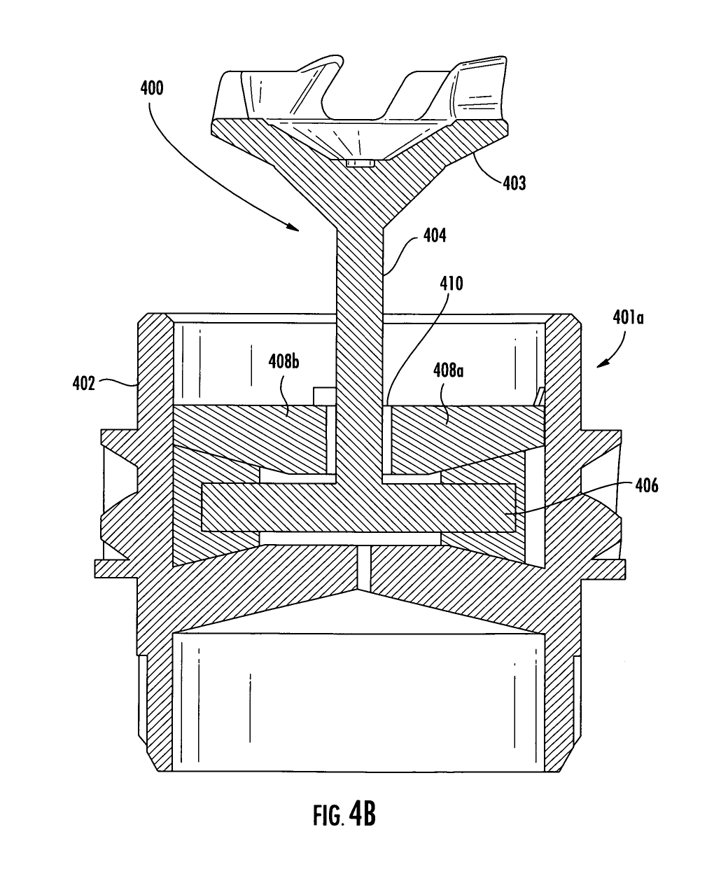

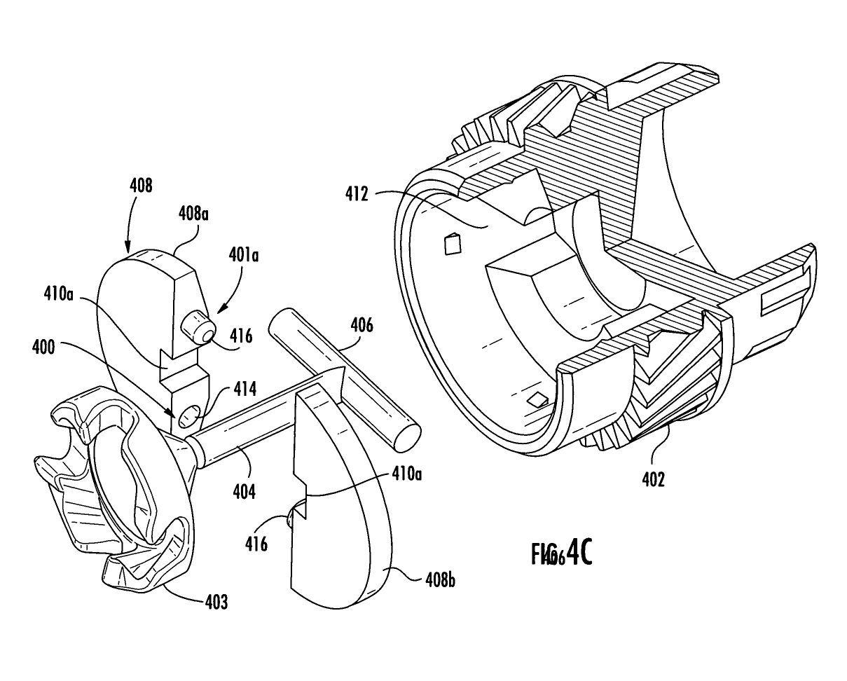

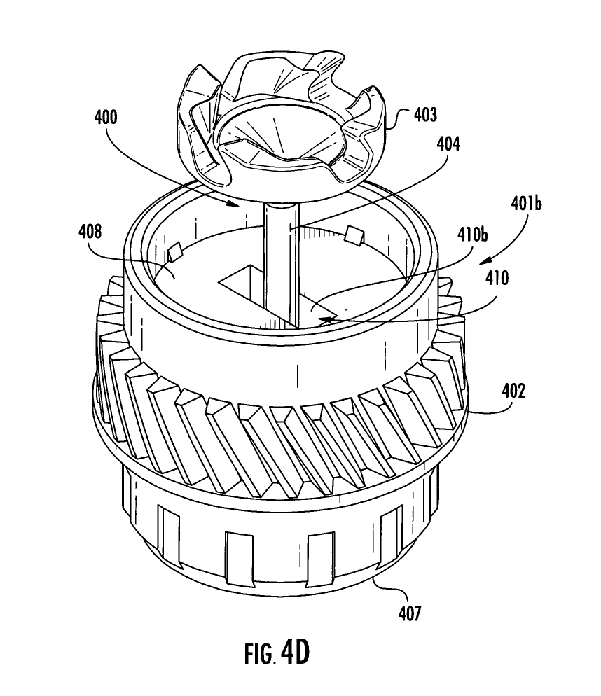

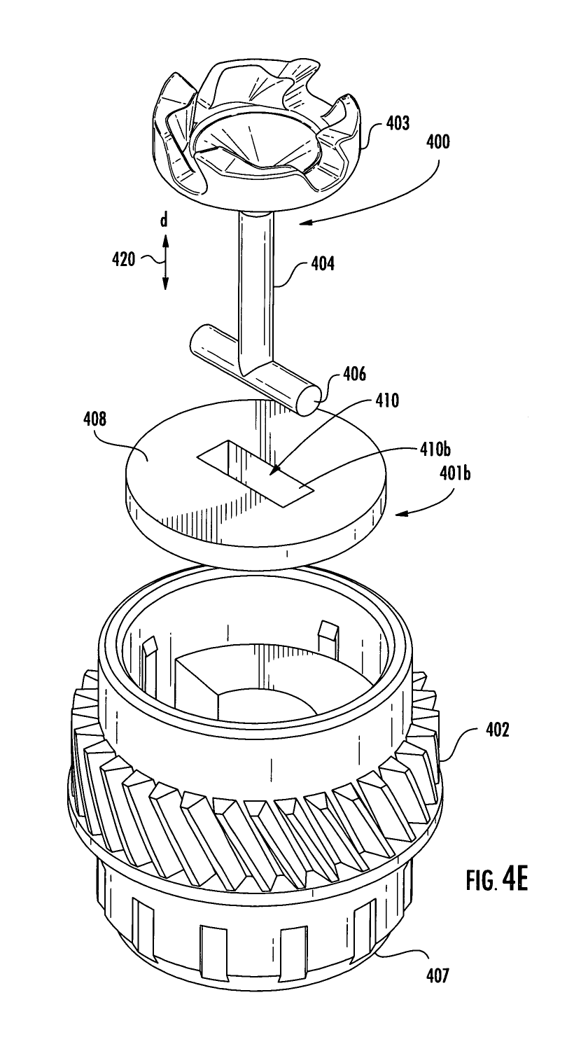

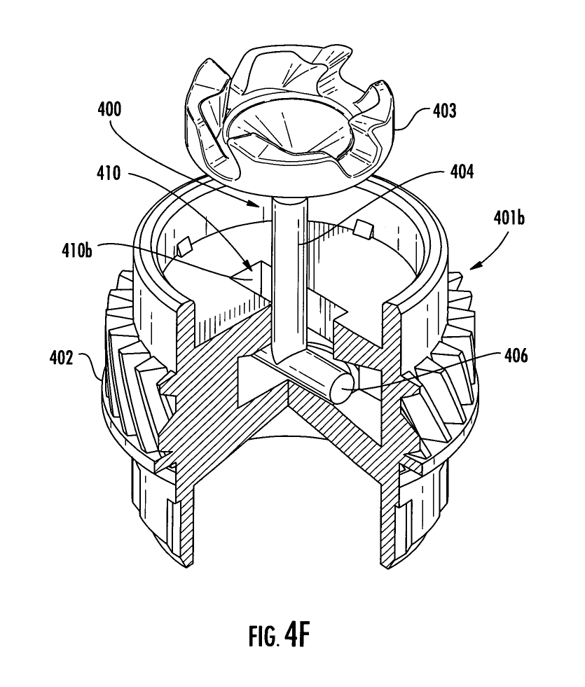

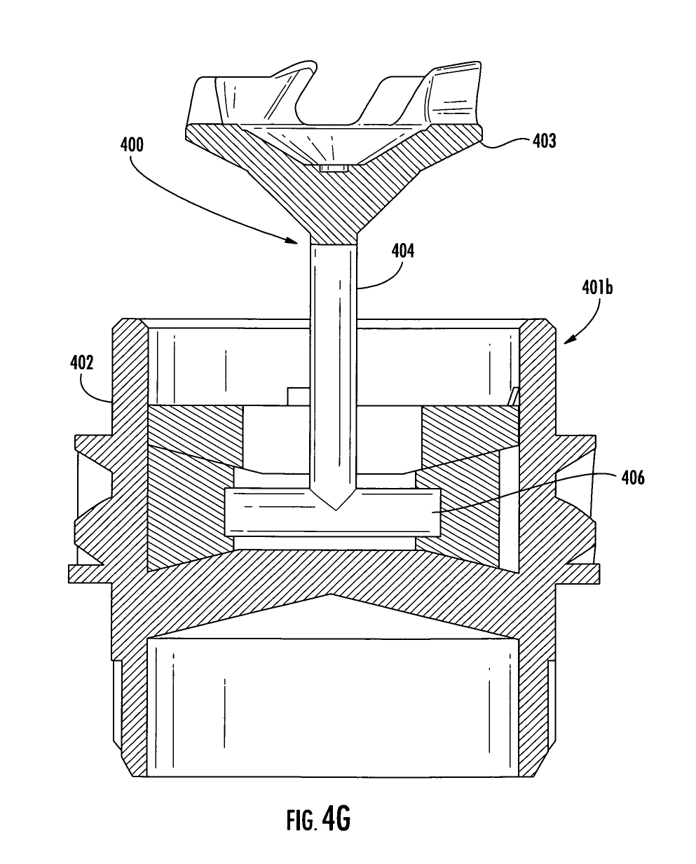

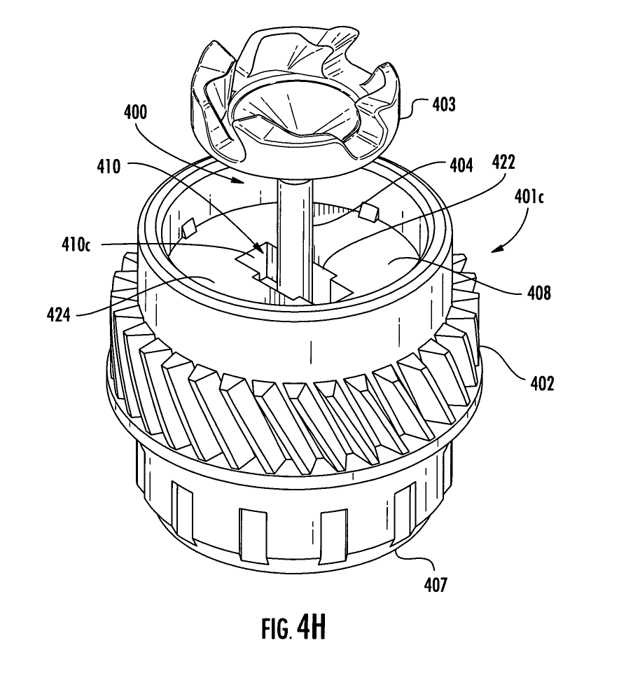

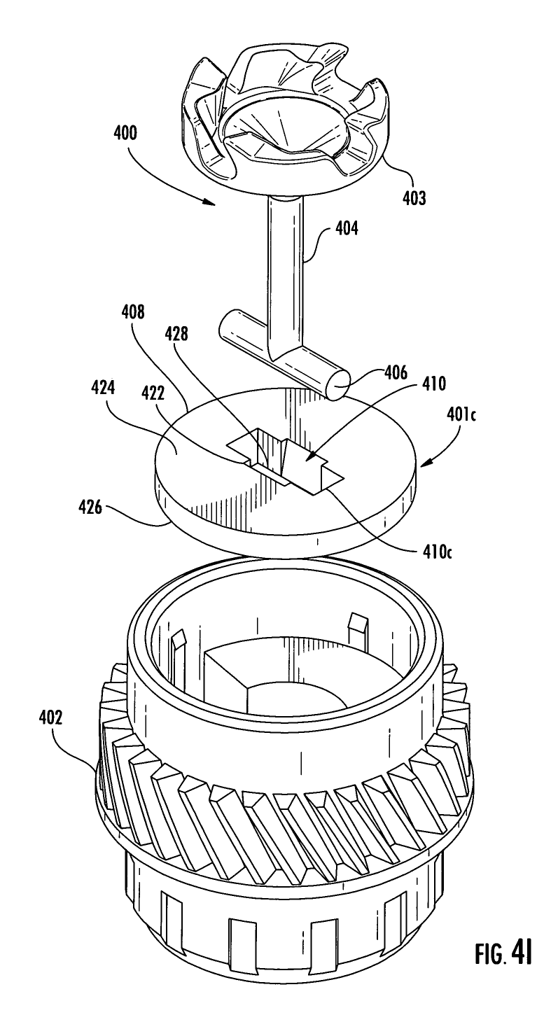

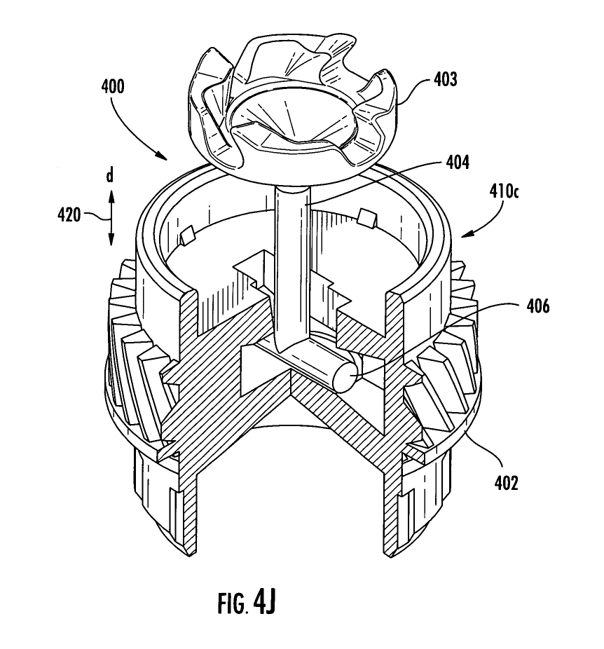

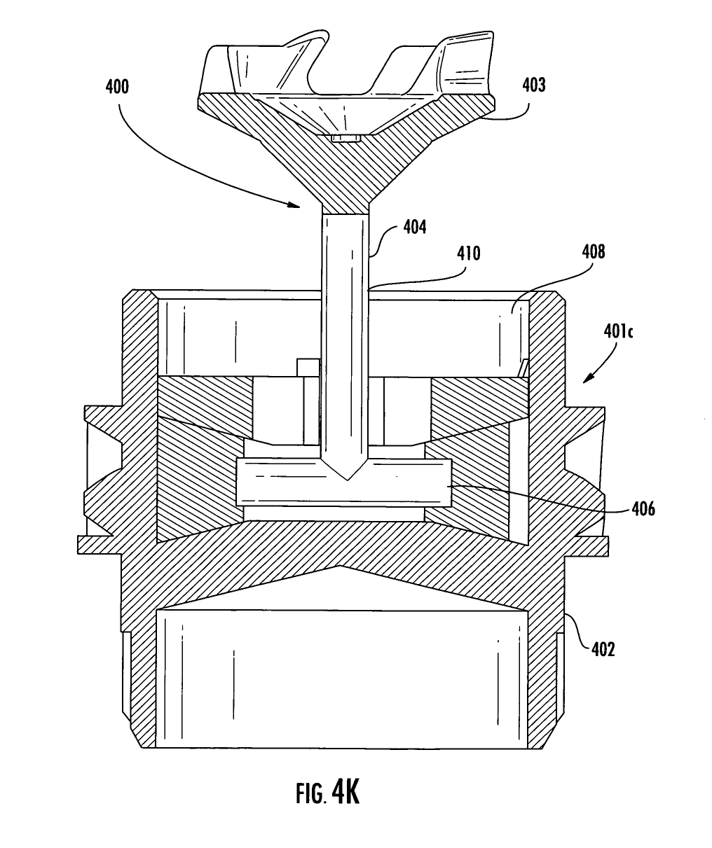

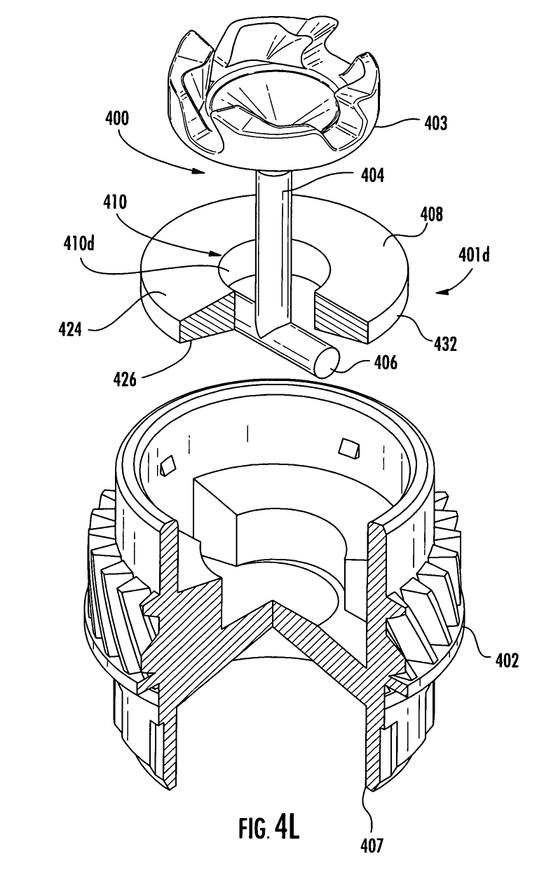

FIGS. 4A-4M illustrate three aspects of a Concept D. FIGS. 4A-4M show a coupling member 400 and a gear hub 402. The coupling member 400 includes a receiving member portion 403, and a base portion 405 with a shaft 404 and a T-bar portion 406.

FIGS. 4A-4C illustrate a first “square slot” aspect 401a of Concept D, FIGS. 4D-4G illustrate a second “rectangle slot” aspect 401b of Concept D, FIGS. 4H-4K illustrate a third “rectangle slot with bevel” aspect 401c of Concept D, and FIGS. 4L and 4M illustrate a fourth “circular opening” aspect 401d of Concept D, which is a modification to any of these aspects.

As shown in FIGS. 4A-4M, the coupling member 400 includes a receiving member portion 403. The receiving member portion 403 of the coupling member 400 is preferably in the form of a gear tooth receiving portion 403a (see FIG. 4A) and can be the same as or different from the receiving member portion 103 shown in FIG. 1A. The coupling member 400 is preferably connected/coupled to the gear hub 402, which can be connected to a rotating part, not shown, such as a drum or an OPC drum, at a bottom portion 407 (see FIGS. 4A, 4H, 4L) of the gear hub 402.

Generic components of these aspects of Concept D are described with reference to FIGS. 4A-4C. FIG. 4A illustrates a coupling member 400, which includes a receiving portion 403, and the base portion 405 with the shaft 404 and the T-bar portion 406. The shaft 404 passes through a cover 408, and the cover 403 includes a slot 410, such as a square shaped slot 410a, through which the shaft 404 passes. The cover 408 may be snap-fitted to an interior 412 (see FIG. 4A) of the gear hub 404, and can be made of one or more pieces. As shown in FIG. 4C, the cover 408 is made of two pieces 408a, 408b that fit together via corresponding alignment holes 414 and pins 416.

The gear hub 402, as shown in FIG. 4A, includes recesses 418 that correspond to the T-bar portion 406 of the coupling member 400. These recesses 418 are configured to allow the T-bar member 406 to rest therewithin, providing a rotational degree of freedom of approximately 5°-10° (five to ten degrees), as well as contact surfaces for transmitting torque. The shape of slot 410 of the cover 408 and the size of the T-bar portion 406 are preferably varied in the second and third aspects 401b, 401c.

In FIGS. 4D-4G (the “rectangle slot” aspect 401b), the slot 410 is a rectangle shaped slot 410b. In this aspect 401b, the length of the T-bar portion 406, as shown in FIG. 4E may be made shorter (relative to the T-bar 404 shown in FIG. 4C). As a result, the coupling member 400 has a lateral degree of freedom, which is lateral to a longitudinal direction (d) 420 (see FIG. 4E). The length of the T-bar portion 406 shown in FIG. 4E (i.e. the length of the lateral bar) is made longer than a dimension of the slot 410, so that the cover 408 inhibits a complete separation of the coupling member 400 from the gear hub 402.

In FIGS. 4H-4K (the “rectangle slot with bevel” aspect 401c), the slot 410 is in the form of a rectangle with bevel shaped slot 410c having a beveled edge portion 422. A top surface 424 of the cover 408 has a “+” shape, whereas, in the shown example, a bottom surface 426 (see FIG. 4I) of the cover 408 maintains a rectangle shape 428. The beveled portion edge may be arranged to coincide with the shaft 404 of the coupling member 400. As shown in FIG. 4J, the beveled edge portion 422 allows for an additional degree of freedom, with respect to the prior aspects, in which the coupling member 400 can rotate (has an angular degree of freedom) of 5°-10°, in at least one dimension with respect to a longitudinal direction (d) 420. As shown in FIG. 4J, the coupling member 400 preferably has the T-bar portion 406 that engages with a base surface 440 of the gear hub 402 with a rotational degree of freedom with respect to a rotational axis of the rotating part.

The slots 410 discussed above (i.e., the square shaped slot 410a, the rectangle shaped slot 410b, or the rectangle with bevel shaped slot 410c) may be modified so as to be circular shaped or oval shaped. For example, FIG. 4L illustrates a slot 410, such as in the form of a circular shaped slot 410d with no beveled edge portion 422. A beveled edge portion may be provided where a size of the circle on the bottom surface 426 of the cover 408 (on a gear hub 402 side of the cover 408) is smaller than a size of a circle perimeter 432 on the top surface 424 of the cover 408 (on a receiving member portion 403 side of the cover 408). A cross-sectional view of this modification is shown in FIG. 4M. In this Figure, the cover 408 is shown as having an interior angle 434, with respect to a lateral direction 436, of 14° (fourteen degrees). With the structures of this modification, the coupling member 400 is secured to the gear hub 402, but has various restricted degrees of freedom. Further, in another modification, the circular shaped slot 410d may be replaced with an oval slot (not shown), and such an oval slot may also be provided with a bevel.

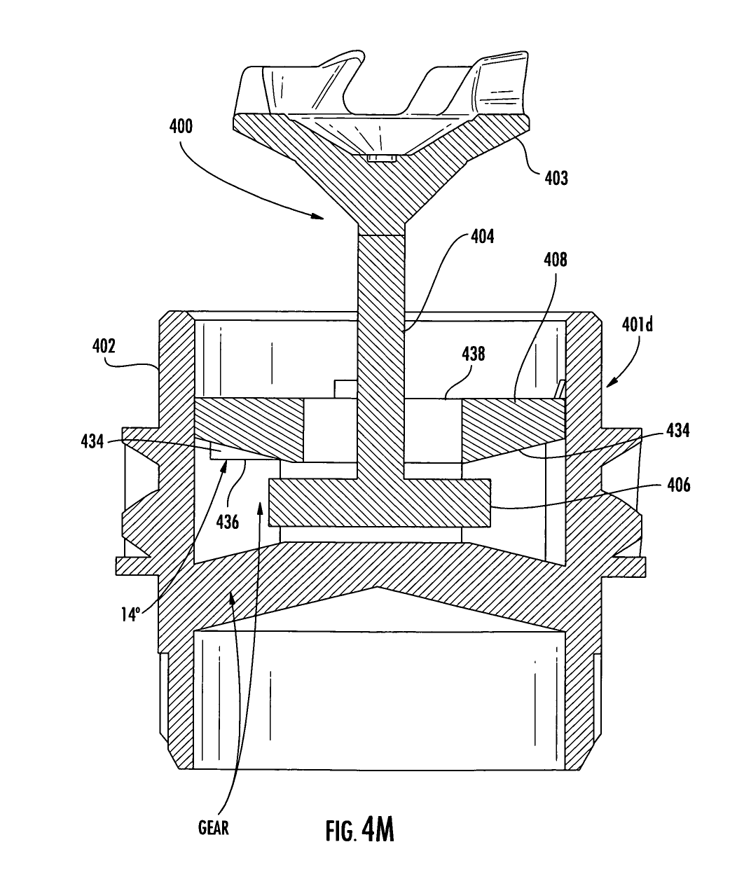

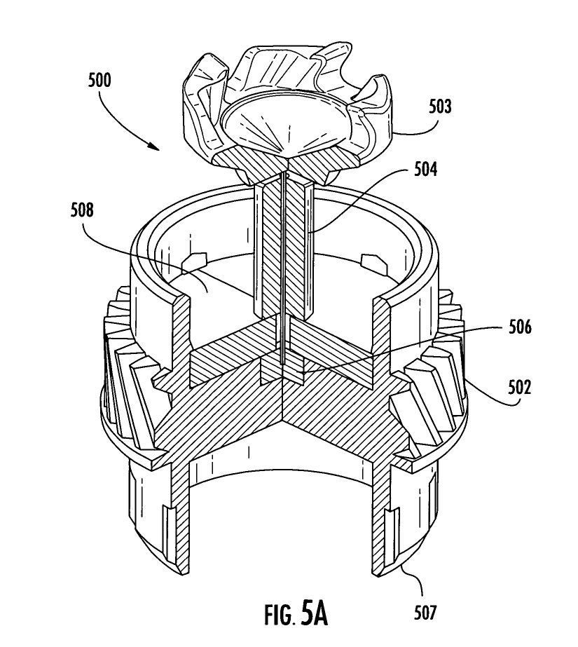

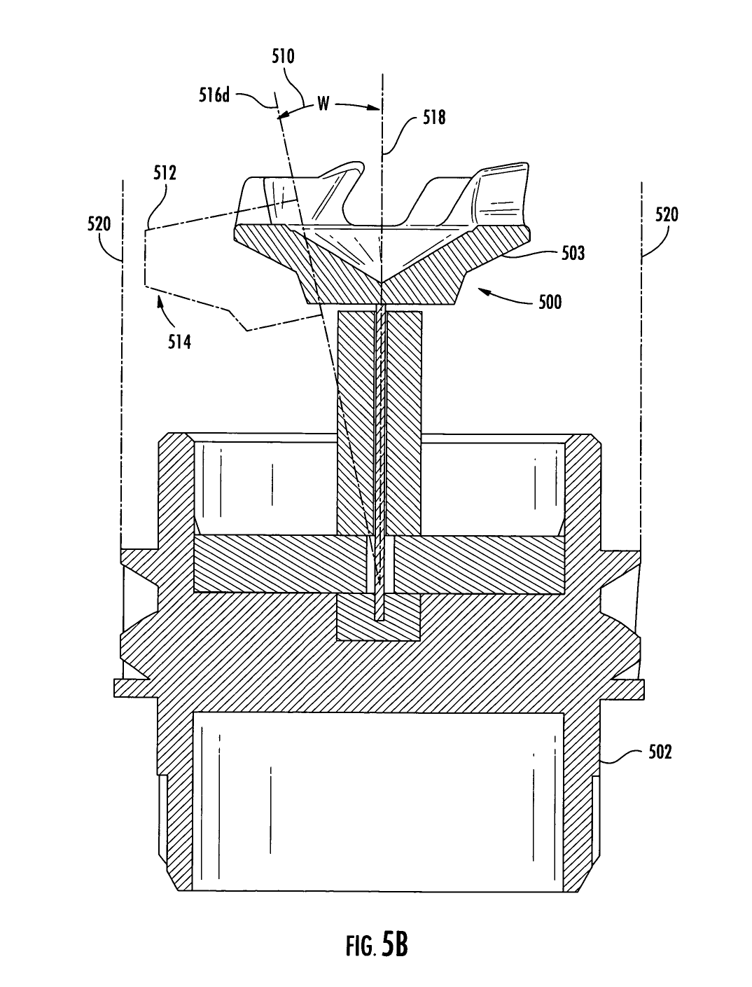

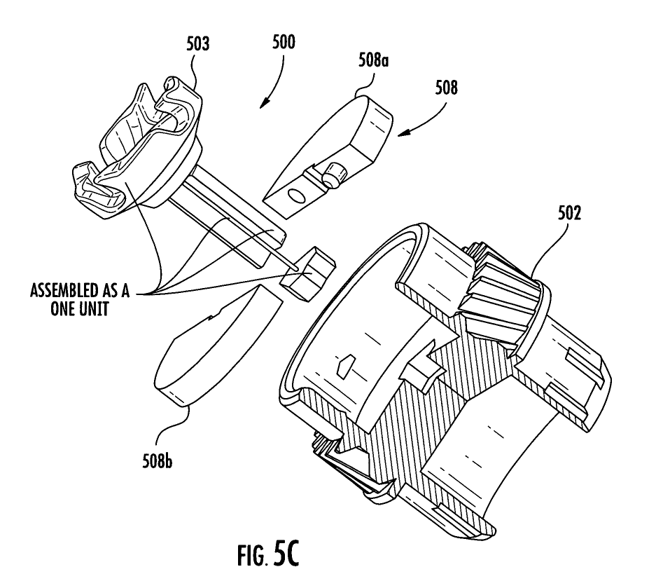

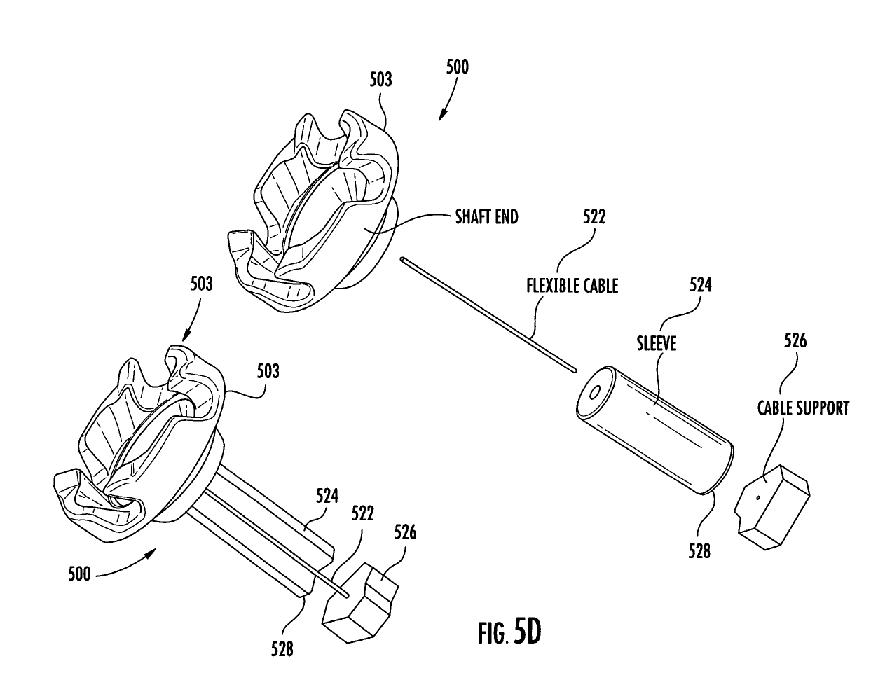

FIGS. 5A-5D illustrate a Concept E. FIG. 5A shows a coupling member 500 and a gear hub 502. The coupling member 500 includes a receiving member portion 503 and a shaft 504 having a base member 506 secured to a cover 508, which is snap-fit to the gear hub 502. The coupling member 500 has degrees of freedom by an angle W 510, where W can be between about 15° (fifteen degrees) and 45° (forty-five degrees), such as approximately 20° (twenty degrees). This degree of freedom can be controlled by the shape and material of the shaft 504 of the coupling member 500 such that an end 512 of the coupling member 500 maintains a position 514 that does not extend, in a direction (d) 516 lateral to a longitudinal axis 518, past a furthest lateral position 520 of the gear hub 502. This furthest lateral position 520 is shown by the dotted lines in FIG. 5B.

FIG. 5C illustrates a partially exploded view, in which the cover 508 (which is formed by two pieces 508a, 508b) is separated. Here, the coupling member 500 is shown as being assembled as one unit, prior to installation into the gear hub 502 via the cover 508. FIG. 5D illustrates the components of the coupling member 500, which includes the receiving member portion 503 or a shaft end connected to a flexible cable 522.

As shown in FIG. 5D, the flexible cable 522 is surrounded by a sleeve 524, with a cable support 526 provided at an end 528 thereof. The cover 508, as shown in the Figures, is positioned between the sleeve 524 and the cable support 526 when installed into the gear hub 502. As shown in FIG. 5C, the coupling member 500 and the gear hub 502 may be coupled to each other by the flexible cable 522, such as a wire, surrounded by the sleeve 524, i.e., sleeved wire.

In this concept, the flexible cable 522 or wire can be made of a metal or a wound fiber. Preferably the material has an elasticity (alone or in combination with a material of the sleeve 524) that provides a spring-like effect to maintain a longitudinal directional alignment, but is flexible to allow for a degree of angular freedom in one or more directions relative to the longitudinal direction. The shape and/or material of the sleeve 526 may be modified so as to restrict this angular freedom to one or particular dimensions/direction/planes.

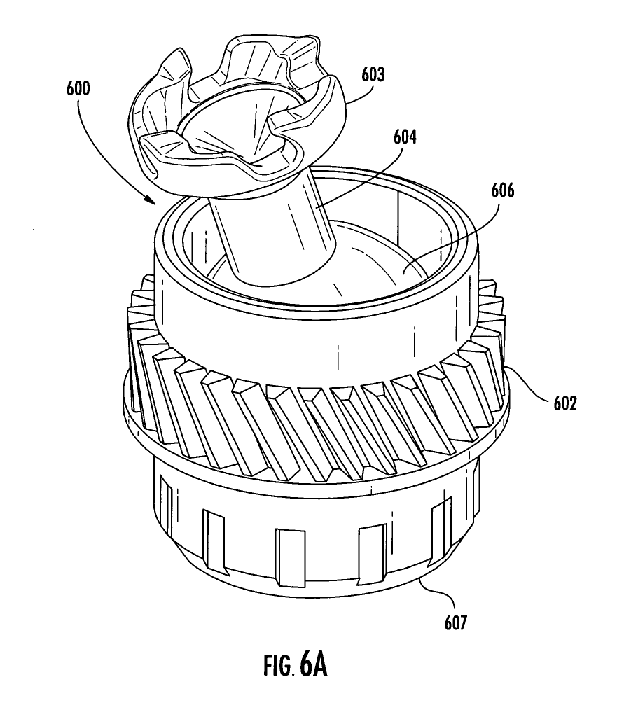

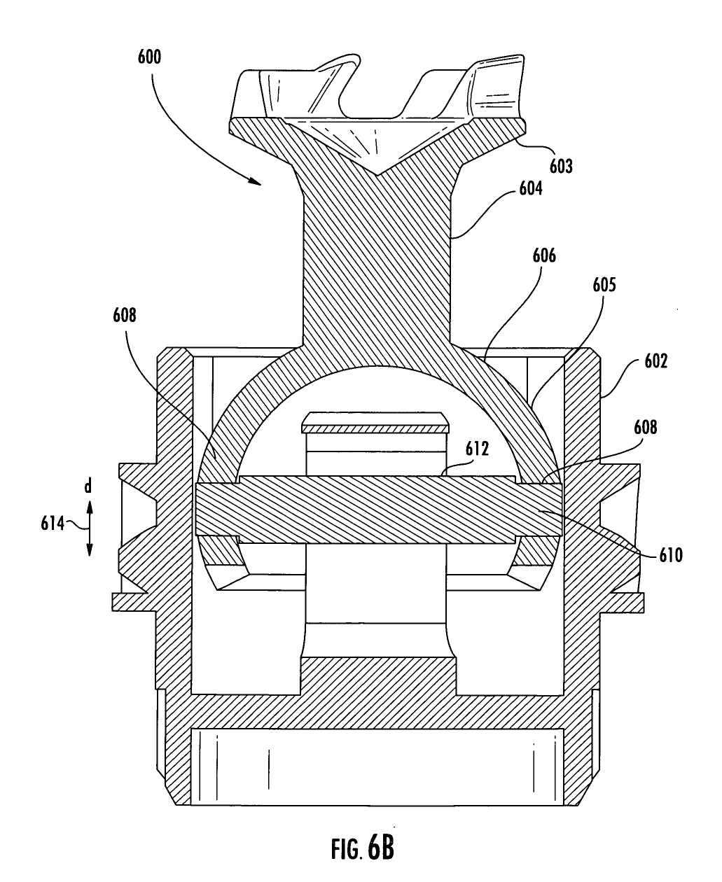

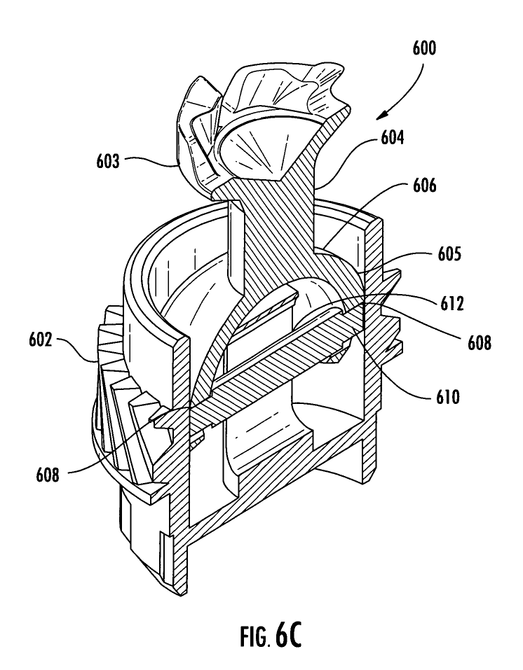

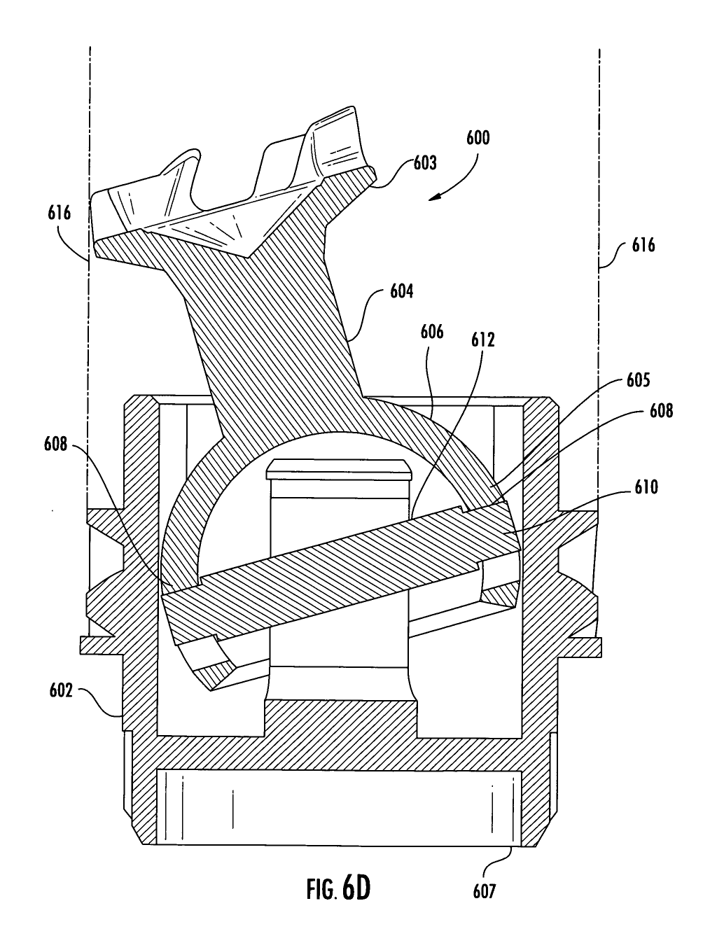

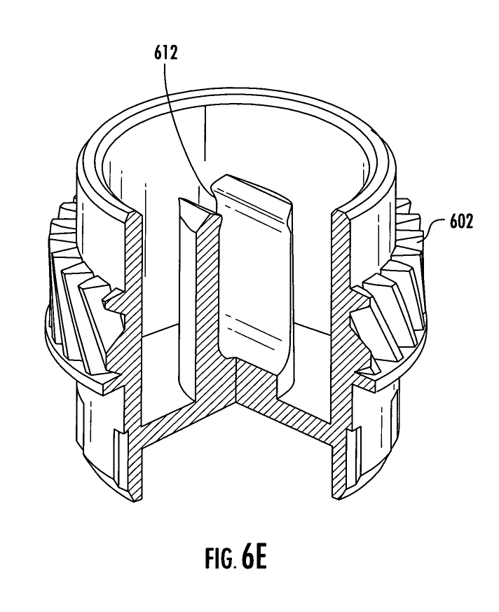

FIGS. 6A-6E illustrate a Concept F. Here, the coupling member 600 (shown enlarged in FIG. 6D) has a stem portion 604 and a base portion 605 (see FIG. 6B) having a spherical shape 606 with one or more (such as two) snap-fit slots 608. A pin 610 extends through a slot 612 of the gear hub 602 (FIGS. 6B-6C). This slot 612 of the gear hub 602 can be elongated in a longitudinal direction (d) 614 (see FIG. 6B) to provide a degree of longitudinal freedom. In the shown example, no degree of rotational freedom (with respect to a rotational direction of a rotational part) is provided, but a degree of rotational freedom with respect to an offset relative to the longitudinal direction (d) 614 is provided by rotating the coupling member 600 relative the gear hub 602, with the pin 610 as an axis of rotation. FIG. 6A illustrates this rotational freedom, and FIG. 6D illustrates this rotational freedom as limited by the slot 612 of the gear hub 602 (shown enlarged in FIG. 6D) or other limiting structure 616 (by way of the dashed lines). FIG. 6E shows the gear hub 602 with the slot 612.

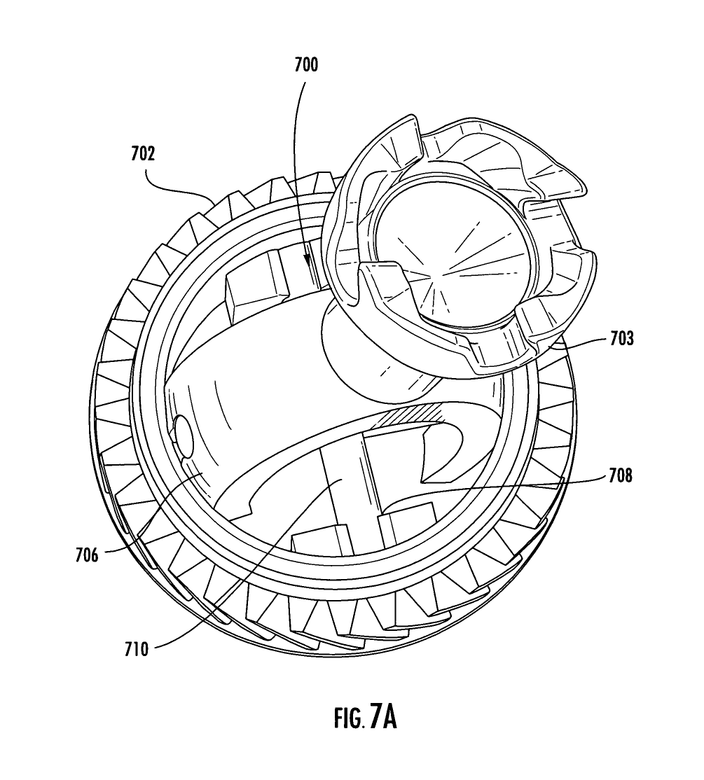

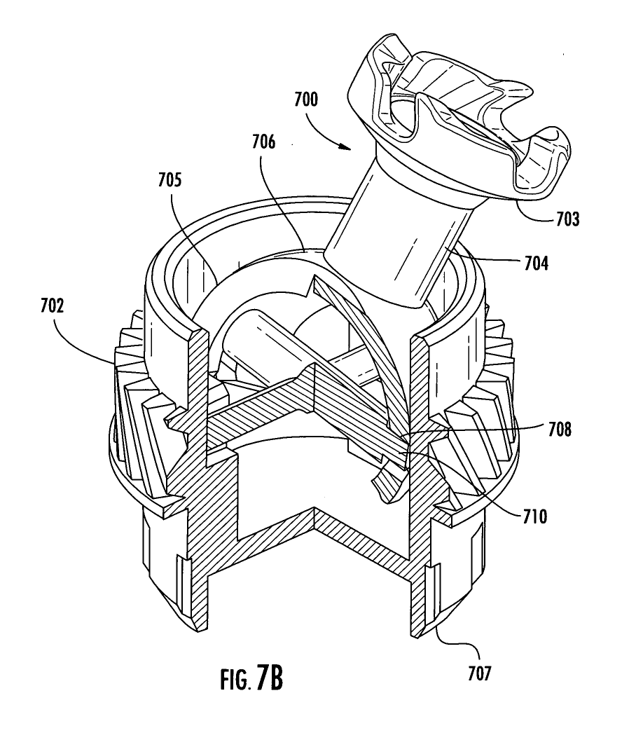

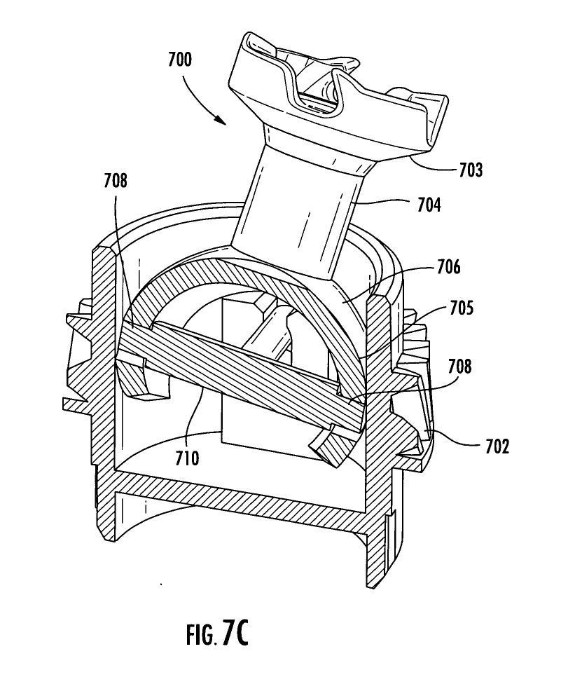

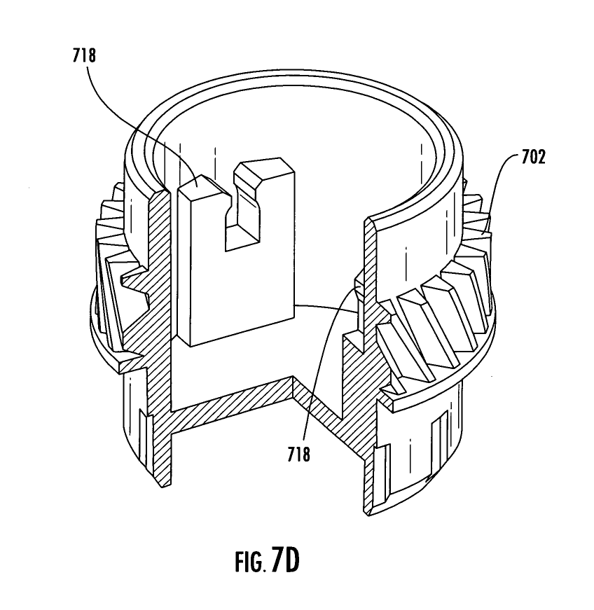

FIGS. 7A-7E illustrate a Concept G. Here, the coupling member 700 is mounted by a bi-directional pin, which includes a generally x-shaped pin structure 710, and will be described as a two-pin structure 712. However, as shown in FIG. 7E, this two-pin structure 712 can be a single unit, which can be made of a single piece of continuous material.

The coupling member 700 has a U-shaped spherical base 706, which can snap-fit into a first pin 714 (see FIG. 7E) of the two-pin structure 712, and has a first degree of rotational freedom with respect to the longitudinal direction. A second pin 716 (see FIG. 7E) of the two-pin 712 structure is snap-fitted to corresponding snap recesses of the gear hub 702, as shown in FIGS. 7A and 7D-E. This second pin 716 provides a second degree of rotational freedom with respect to the longitudinal direction.

Thus, the coupling member 700 and the gear hub 702 may be coupled to each other by the x-shaped pin structure 710 (see FIG. that provides at least two rotational degrees of freedom with respect to a longitudinal direction, the x-shaped pin structure 710 including a first pin 714 and a second pin 716 joined together, one of either the first pin 714 or the second pin 716 being snap-fit to the gear hub 702.

As shown in FIG. 7D, the gear hub 700 can include opposing snap-fit retaining portions 718. FIG. 7E illustrates an exemplary “two-pin” structure 712, which includes a first pin 714 and a second pin 716 forming a “x” shape 720. The first pin 714 can include recessed ends 722, as shown in FIG. 7E to engage and align with the snap-fit retaining portions 718 shown in FIG. 7D. When assembled, as shown in FIGS. 7A-7C, the coupling member 700 has two degrees of rotational freedom, provided by the “two-pin” structure 712.

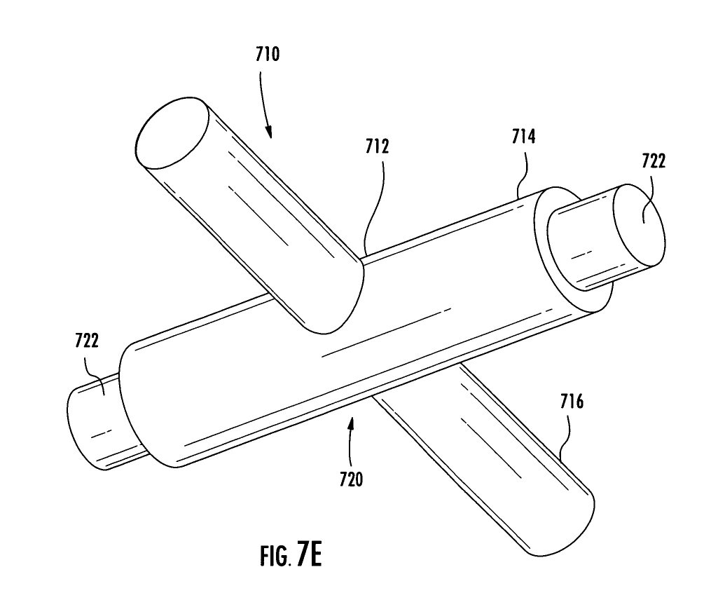

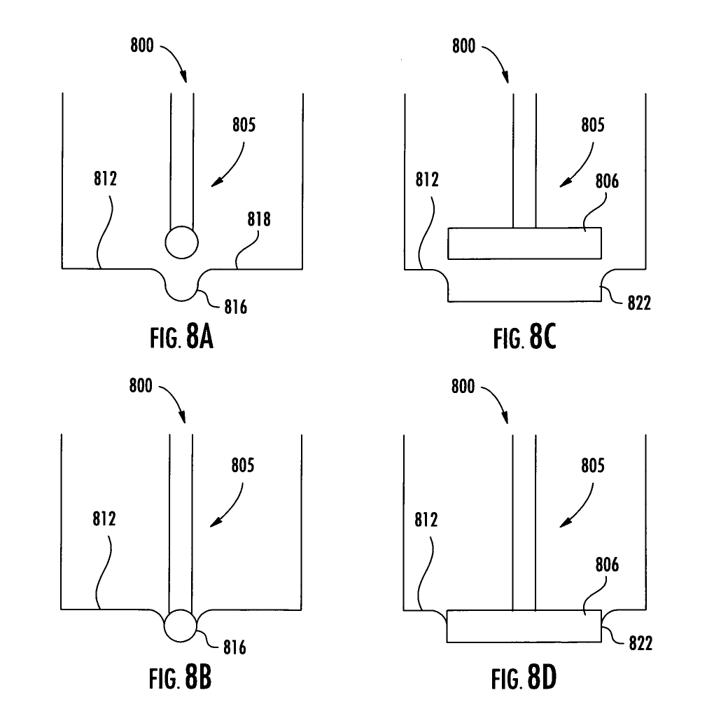

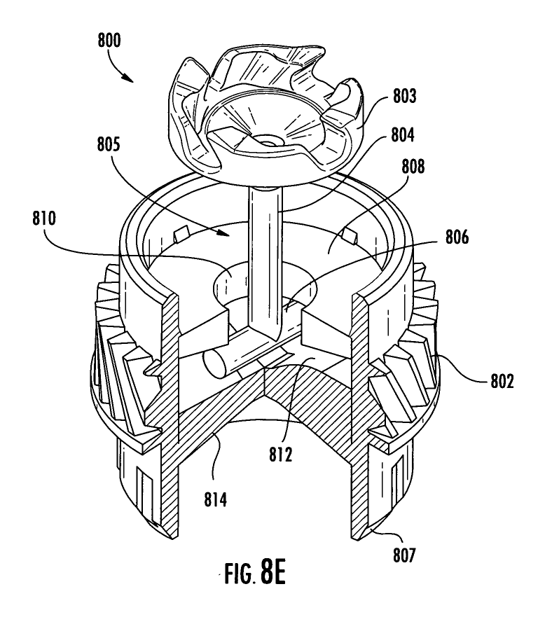

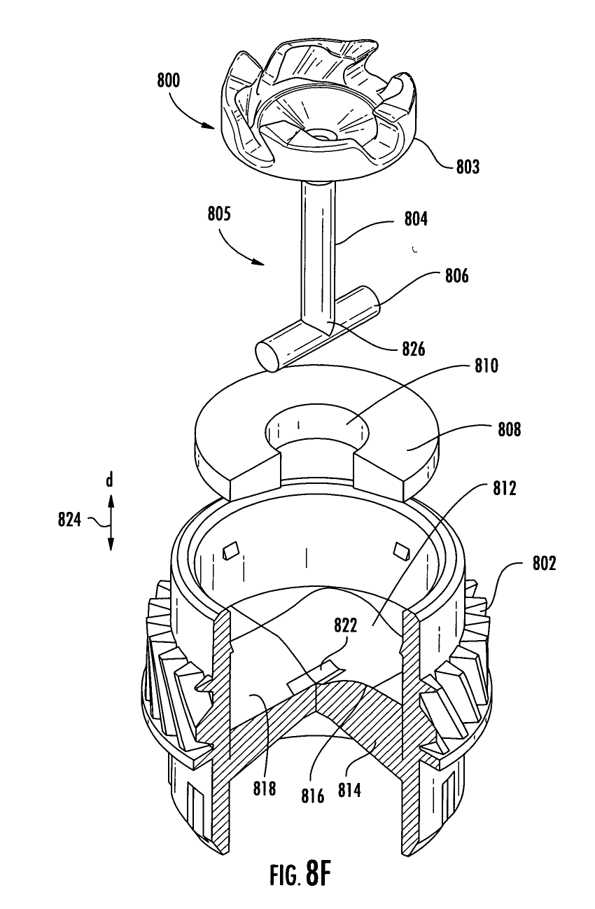

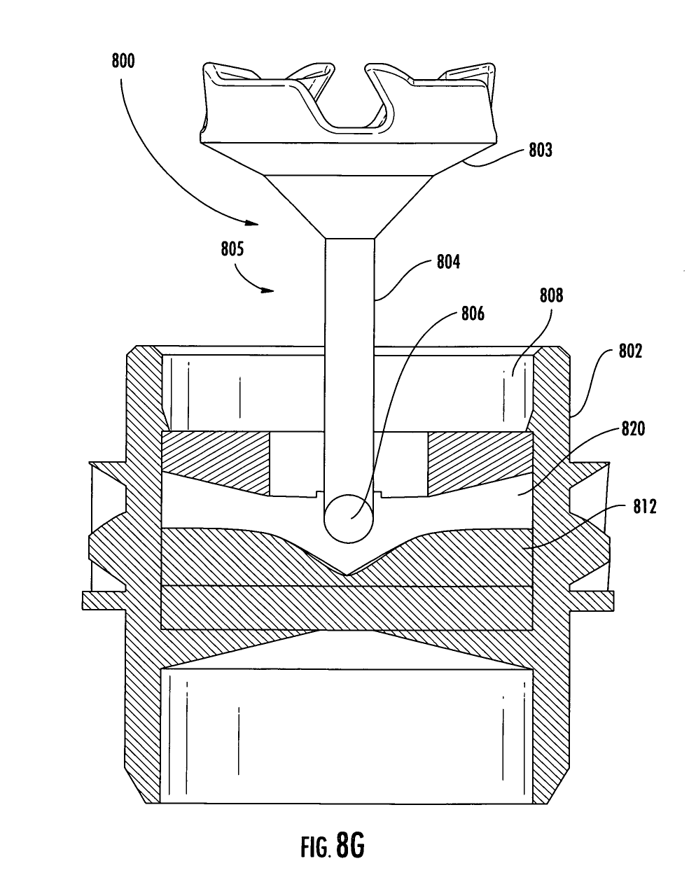

FIGS. 8A-8D schematically illustrate a Concept H. Here, as shown in FIGS. 8E-8G, a coupling member 800 having a receiving member portion 803, a base portion 805 with a shaft 804 and a T-bar portion 806, and a gear hub 802, is utilized with a contoured base surface 812 on a base 814 of the gear hub 802. As shown in FIG. 8F, the contoured base surface 812 includes a slot 822 that has a shape that corresponds to the T-bar portion 806 of the coupling member 800, and further includes rounded entry surfaces 816 on at least an entrance side 818. FIGS. 8A-8B schematically illustrate a side cross-sectional view of the base portion 805 of the coupling member 800 and the contoured base surface 812 just prior to (FIG. 8A) and after (FIG. 8B) insertion. FIGS. 8C-8D schematically illustrate a front cross-sectional view of the base portion 805 of the coupling member 800 and the contoured surface 812 just prior to (FIG. 8C) and after (FIG. 8D) insertion. Aspects of this concept can be implemented together with aspects of the other concepts described herein.

For example, with reference to the aspects of Concept D, a cover 808 (see FIGS. 8E-8G) may be utilized. For example, any of the “square shaped slot,” “rectangle shaped slot,” and “rectangle with bevel shaped slot” covers, discussed above, may be utilized. Circular and oval (with or without a bevel) slots can also be utilized. Further, even though FIGS. 8C and 8D illustrate the T-bar portion 806 and the slot 822 as having a same width, the T-bar portion 806 may be modified to be shorter (width-wise) than the slot 822, providing a degree of lateral movement (a lateral degree of freedom) with respect to a longitudinal direction, as in the examples shown in FIGS. 8E-8G.

In the examples shown in FIGS. 8E-8G, a cover 808 with a circular slot 810 is used. As shown in FIG. 8G, a gap 820 is provided between the contoured base surface 812 and the interior side of the cover 808. In these examples, several restricted degrees of freedom are provided. In particular, the T-bar portion 806 has a degree of lateral movement (a lateral degree of freedom) with respect to a longitudinal direction (d) 824 (see FIG. 8F), a degree of rotational movement (a rotational degree of freedom) with respect to a longitudinal axis as an axis of rotation when the coupling member 800 (see FIG. 8F) is not pressed into the slot 822 (see FIG. 8F) provided by the contoured base surface 812 (see FIG. 8F), and a degree of longitudinal movement (a longitudinal degree of freedom) with respect to the longitudinal direction (d) 824 (see FIG. 8F). The slot 810 (see FIG. 8F) also provides a degree of rotational freedom with respect to angularly offsetting the T-bar portion 806 (see FIG. 8F) with respect to the longitudinal axis, in a manner similar to that discussed above with respect to Concept D.

Exemplary spatial relationships between the base portion 805 of the coupling member 800, the slot 822 and the contoured surface 812 are illustrated in FIG. 8F. Here, the base portion 805 of the coupling member 800 is shown as being made of a shaft 804 and a T-bar portion 806, which extends laterally from an end 826 of the shaft 804. Here, the T-bar portion 806 is merely one bar that extends in the lateral direction, in opposing lateral directions away from the end 826 of the shaft 804. In an alternative arrangement, two or more T-bar portions 806 may be utilized which extend, laterally, from the end 826 of the shaft 804, in directions that are not directly opposing. In particular, the T-bar portion 806 may extend at an angle perpendicular to one another, or at another angle, such as 120° (one hundred twenty degrees). In such arrangements, the contoured surface 812 would include corresponding contours (slots) to engaged with the respective T-bar portions 806. The T-bar portion 806 may also form an X-shape, whereas the contoured base surface 812 would then form a corresponding slotted X-shape.

Thus, the coupling member 800 has the T-bar portion 806 and the gear hub 802 includes a contoured base surface 812 to receive the T-bar portion 806, where the contoured base surface 812 has a slot 822 with rounded entry surfaces 816. The coupling member 800 has the base portion 805, including a shaft 804 and one or more T-bar portions 806 extending laterally from an end of the shaft 804. The shaft 804 extends through a cover 808 that includes a circular slot 810, the cover 808 being connected to the gear hub 802; and a diameter or dimension of the circular slot 810 is less than a length or corresponding dimension of the one or more T-bar portions 806, such that the cover 808 restricts the coupling member 800 from being completely disconnected from the gear hub 802. The cylindrical body includes a photoconductor. The image forming apparatus comprises the rotating part.

As shown in FIG. 8G, the T-bar portion 806 has a smaller diameter or dimension than a diameter or dimension of the gap 820. This smaller dimension of the T-bar portion 806 is also smaller than a corresponding diameter or dimension of the contoured base surface 812 and the slot 822 (see FIG. 8F) formed by the contoured base surface 812.

Aspects of any of the concepts can be combined with other aspects of other concepts to obtain varying levels and degrees of freedom between a coupling member and a hub gear.

Materials for manufacturing parts and/or gear mechanisms discussed herein include engineering plastics, including polyester elastomers, POM (polyoxymethylene, a kind of polyacetal) and polycarbonate resin. However, other materials may be the same or at least similar to that known in the art for prior parts. Additionally, combinations of resins or composite resin and fiber materials may be used. Further, strength members (such as metal pins) may be utilized as supporting inner members for the structures shown in the drawings. The elastic members discussed above may be made of the same or similar materials, and may also be made out of various metals and alloys.

In view of the above, some of the above discussed parts may be either entirely or partially comprised of elastic materials. The elasticity of a material facilitates engagement/coupling with other parts.

Also, in some of the above-discussed implementations, various widths and sizes may be varied depending on the shape and form of a to-be-coupled part. Further, in some respects, surface shapes and edge lengths between the shown structures may be varied and, in aspects, the intersections of these edges and/or the edges themselves may be rounded in some embodiments (not shown).

Many modifications and other embodiments of the disclosure will come to mind to one skilled in the art to which this disclosure pertains having the benefit of the teachings presented in the foregoing descriptions and the associated drawings. The embodiments described herein are meant to be illustrative and are not intended to be limiting. Although specific terms are employed herein, they are used in a generic and descriptive sense only and for purposes of limitation. The invention is not limited in its application to the details of the construction and to the arrangement of the components set forth in the above description or as illustrated in the drawings.

What is claimed is:

1. A rotating part installable in an image forming apparatus, comprising:
a coupling member configured to have one or more restricted degrees of freedom; and,
a gear hub to rotationally engage the coupling member.

2. The rotating part according to claim 1, further comprising:
a cover to at least partially control an alignment of a shaft of the coupling member with respect to the gear hub.

3. The rotating part according to claim 2, wherein the cover includes a square shaped slot or a circular shaped slot.

4. The rotating part according to claim 2, wherein the cover includes a rectangle shaped slot or an oval shaped slot.

5. The rotating part according to claim 4, wherein the rectangle shaped slot or the oval shaped slot includes one or more beveled edge portions to allow the shaft of the coupling member an angular degree of freedom.

6. The rotating part according to claim 1, wherein the coupling member includes a U-shaped base portion.

7. The rotating part according to claim 6, wherein the U-shaped base portion includes snap-fit portions to engage a pin that couples to the gear hub.

8. The rotating part according to claim 7, wherein the U-shaped base is a cylindrical shape.

9. The rotating part according to claim 7, wherein the U-shaped base is a spherical shape.

10. The rotating part according to claim 7, wherein the pin is inserted through elongated slots formed in a snap-fit portion that is snap-fitted to the gear hub.

11. The rotating part according to claim 1, wherein the coupling member and the gear hub are coupled to each other by projections that allow for a restricted rotational degree of freedom therebetween, the projections including base stems and tabs provided at ends of the base stems, the base stems passing though slots in a cover, the cover being secured to the coupling member or the gear hub, and the tabs restricting a complete separation of the coupling member from the gear hub by engaging a surface of the cover.

12. The rotating part according to claim 1, wherein the coupling member and the gear hub are coupled to each other by a spring member.

13. The rotating part according to claim 12, wherein the spring member is fitted to the gear hub, such that the spring member has an angular degree of rotational freedom at a fitting pivot point therewith.

14. The rotating part according to claim 1, wherein the coupling member has a T-bar portion, where the T-bar portion engages with a base surface of the gear hub with a rotational degree of freedom with respect to a rotational axis of the rotating part.

15. The rotating part according to claim 1, wherein the coupling member and the gear hub are coupled to each other by a flexible cable surrounded by a sleeve.

16. The rotating part according to claim 1, wherein the coupling member and the gear hub are coupled to each other by an x-shaped pin structure that provides at least two rotational degrees of freedom with respect to a longitudinal direction, the x-shaped pin structure including a first pin and a second pin joined together, one of either the first pin or the second pin being snap-fit to the gear hub.

17. The rotating part according to claim 1, wherein the coupling member has a T-bar portion and the gear hub includes a contoured base surface to receive the T-bar portion, where the contoured base surface has a slot with rounded entry surfaces.

18. The rotating part according to claim 1, wherein: the coupling member has a base portion, including a shaft and one or more T-bar portion extending laterally from an end of the shaft; the shaft extends through a cover that includes a slot, the cover being connected to the gear hub; and a diameter or dimension of the slot is less than a length or corresponding dimension of the one or more T-bar portions, such that the cover restricts the coupling member from being completely disconnected from the gear hub.

19. The rotating part according to claim 1, further comprising a cylindrical body including a photoconductor.

20. An imaging cartridge for an image forming apparatus comprising the rotating part according to claim 19.
